(19) United States
(12) Patent Application Publication
(10) Pub. No.: US 2011/0169927 A1
(43) Pub. Date: Jul. 14, 2011

(54) Content Presentation in a Three Dimensional Environment

(75) Inventors: Michael William Mages, Oakland, CA (US); Barrett Fox, Berkeley, CA (US); Joaquin Alvarado, Oakland, CA (US); Ben Rigby, San Francisco, CA (US)

(73) Assignee: COCO STUDIOS, Oakland, CA (US)

(21) Appl. No.: 13/005,091

(22) Filed: Jan. 12, 2011

Related U.S. Application Data
(60) Provisional application No. 61/294,732, filed on Jan. 13, 2010.

(51) Int. Cl. H04N 13/04

(52) U.S. Cl. 348/51; 348/E13.026

(57) ABSTRACT

Systems, devices, and methods for displaying method content are described. In some embodiments, media content for display in a virtual three dimensional environment may be described. The virtual three dimensional environment including a representation of the identified media content may be generated. The generated virtual three dimensional environment may be displayed on a display device in communication with the first computing device. The virtual three dimensional environment may be displayed from a vantage point at a first location within the virtual three dimensional environment. Input modifying the virtual three dimensional environment may be detected. The virtual three dimensional environment may be updated in accordance with the detected input. The updated virtual three dimensional environment may be displayed on the display device.

### PRIORITY AND RELATED APPLICATION DATA

This application claims priority to Provisional U.S. Patent Application No. 61/294,732, filed on Jan. 13, 2010, entitled “Internet Enabled 3D Virtual Collaboration Using Game Engine Technology,” by Michael William Mages, et al., which is incorporated herein by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to content provided over a data network such as the Internet, and more specifically to presenting content in a three dimensional environment.

### BACKGROUND

Computer users typically employ many different types of software and computing technologies to meet their computing needs. One common computing task is interacting with digital content. Digital content may include video, audio, images, documents, models, graphs, charts, or any other content that may be processed by a computing device. As computing technology becomes more pervasive, users interact with ever larger amounts of content.

One common mode of interacting with content is passive consumption of the content. For example, users may listen to music or watch movies. However, more complex interactions with content are increasingly popular. Users may comment on audio or video accessed via the Internet, edit documents, or splice together audio or video files to create new content. Further, interaction with content is increasingly performed across different types of media. For example, a user listening to music may look up information about the musician on the internet. As another example, a user may combine a song with a video clip to create a new video, and then publish the new video on the Internet.

In the past, interaction with content was largely a solitary activity for each single user. For example, a user may have listened to music, but not have been able to conveniently share the experience with friends not located in the same room. However, users now often interact with content socially. For example, users of popular Internet services may comment on, rate, or recommend content for each other.

### BRIEF DESCRIPTION OF THE DRAWINGS

The included drawings are for illustrative purposes and serve only to provide examples of possible structures and process steps for the disclosed inventive systems and methods for presenting content in a three dimensional environment. These drawings in no way limit any changes in form and detail that may be made to embodiments by one skilled in the art without departing from the spirit and scope of the disclosure.

FIG. 1 shows a flow diagram of a method 100 for presenting a three dimensional environment, performed in accordance with one embodiment.

FIG. 2 shows a flow diagram of a method 200 for presenting content, performed in accordance with one embodiment.

FIG. 3A shows a flow diagram of a method 300 for storing semantic content information, performed in accordance with one embodiment.

FIG. 3B shows a flow diagram of a method 350 for retrieving semantic content information, performed in accordance with one embodiment.

FIG. 4 shows a system diagram of a system 400 for storing and retrieving semantic content information, in accordance with one embodiment.

FIG. 5 shows a flow diagram of a method 500 for presenting an avatar, performed in accordance with one embodiment.

FIG. 6 shows a flow diagram of a method 600 for interacting with content, performed in accordance with one embodiment.

FIG. 7 shows a flow diagram of a method 700 for collaborating on content, performed in accordance with one embodiment.

FIGS. 8-27 show images of three dimensional environments, provided in accordance with one embodiment.

### DETAILED DESCRIPTION

Applications of systems and methods according to one or more embodiments are described in this section. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosure, it is understood that these examples are not limiting, such that other embodiments may be used and changes may be made without departing from the spirit and scope of the disclosure.

In some embodiments, a three dimensional virtual environment is provided. The three dimensional virtual environment may include a visual and virtual space displayed on a computer screen. The virtual space may appear similar to that of computer games, in which a character or avatar may move about within the virtual space.

In some embodiments, the three dimensional environment may be displayed in a web browser. Alternately, or additionally, the three dimensional environment may be displayed in a standalone application that does not require a web browser. The three dimensional environment may be accessed on various types of computing environments, such as desktop computers, laptop computers, mobile devices, laptops, smart phones, game consoles, tablets, etc.

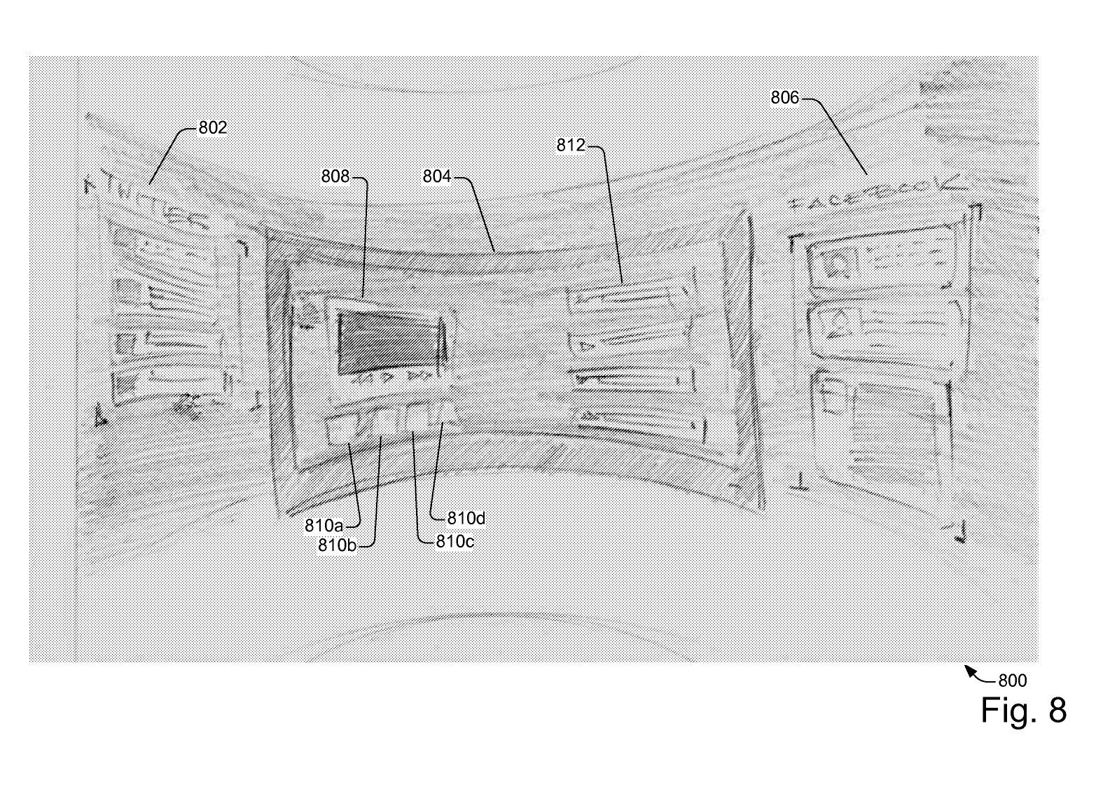

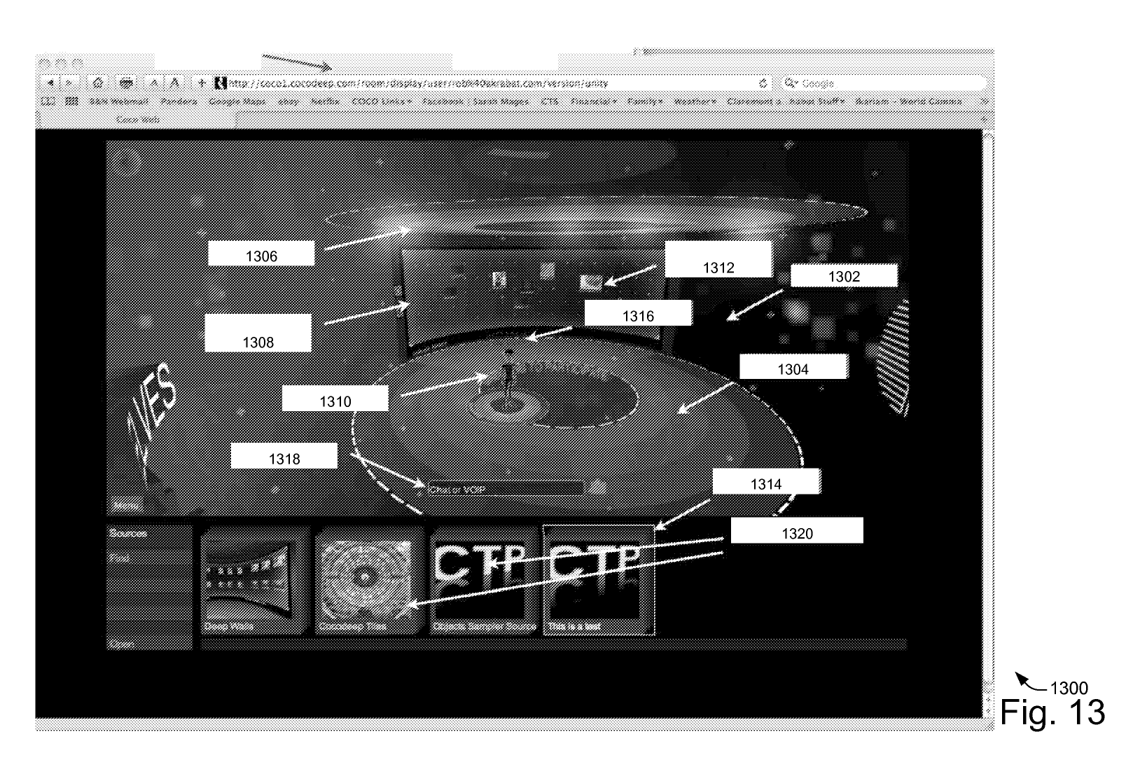

Some features of a three dimensional environment are be discussed herein with respect to FIGS. 8-22, which show images of three dimensional environments provided in accordance with one embodiment. For example, FIG. 13 shows an image of a three dimensional environment 1300. The three dimensional environment 1300 includes a three dimensional room 1302, a deck 1304, a ceiling 1306, a wall 1308, an avatar 1310, content 1312, a two dimensional halo 1314, a three dimensional halo 1316, a chat area 1318, and content thumbnails 1320.

In some embodiments, the three dimensional environment may include an area of open space, which may be referred to herein as a room. The room 1302 is circular. However, the room may alternately be square, rectangular, or any other shape. The room may be at least partially surrounded by virtual surfaces. At the bottom, the room may be bounded by the deck 1304, which is also referred to herein as a floor. At the top, the room may be bounded by the ceiling 1306. At the sides, the room may be bounded by a curved, straight, or otherwise-shaped wall. For example, the room 1302 includes a curved wall 1308. The wall may also be referred to herein as a three dimensional sharing wall. The wall may occupy a fixed or variable portion of the perimeter of the room.

In some embodiments, three dimensional character representations of users can appear in the three dimensional environment. These characters, which are also referred to as avatars, can walk around the virtual environment. For example, the avatar 1310 occupies the room 1302 shown in FIG. 13. A user may enter identification information to log in as a particular avatar. Multiple avatars may occupy the room simultaneously. Avatars may be customizable.

In some embodiments, the virtual characters can place objects that represent files, documents, media, URI's, RSS feeds, and/or three dimensional graphics on the wall or in other areas of the three dimensional environment. These objects are also referred to herein as content. For example, the wall 1308 is displaying the content 1312.

In some embodiments, users may manipulate, share, copy, view, present, annotate and chat about the content. For example, users may chat about the content via the chat area 1318. The chat area 1318 may support text chat, verbal communications, or both. Verbal communications may be conducted via voice-over-IP (VoIP) or via any other form of communication. The history of a chat may be saved as a content object. For example, the history may be saved to the wall 1308 and then may be saved along with the wall. The history of a chat may be reopened and viewed in a viewer or on the wall like other files.

In some embodiments, the wall may include whiteboard functionality that allows users to draw or mark on the wall or content displayed on the wall. The markings may be stored along with the wall, as a record of an interaction between users and the content.

In some embodiments, users may show and share content, move avatars, show emotions, or communicate via text or voice in the three dimensional environment. The three dimensional environment may provide a dedicated environment for rapid and functional collaboration and interaction. In some embodiments, the wall, floor, or ceiling of the room may be used to organize, share and/or collaborate with content.

In some embodiments, a user may have access to two dimensional or three dimensional halos that represents persistent content that is available to the user. For example, the three dimensional environment 1300 includes the two dimensional halo 1314 and the three dimensional halo 1316. The halos may act as visual representations of persistent content that the user collects. The persistent content in the halos may be a source of content displayed on the sharing wall. The two dimensional halo may be arranged as a scroll bar of thumbnail images, and may be located below the three dimensional space. For example, the two dimensional halo 1314 includes the content thumbnails 1320. Each image may represent a file, link, or other content. The three dimensional halo may be arranged as a ring of representational thumbnail images. The three dimensional halo may be positioned around and above the head of the user's avatar. The three dimensional halo may have the same content as the two dimensional halo or may have different content. The two dimensional and/or three dimensional halos may include functions that allow scrolling, labeling, selecting, sorting, and/or searching of the content thumbnails.

In some embodiments, the actions of the avatar may be used to connect the content between the halos and the virtual surfaces in the three dimensional environment. For example, an avatar may drag content from the halo and drop it on the surface of the sharing wall. The avatar may connect the content with a viewer on the sharing wall by a selection action that causes the content to be viewed.

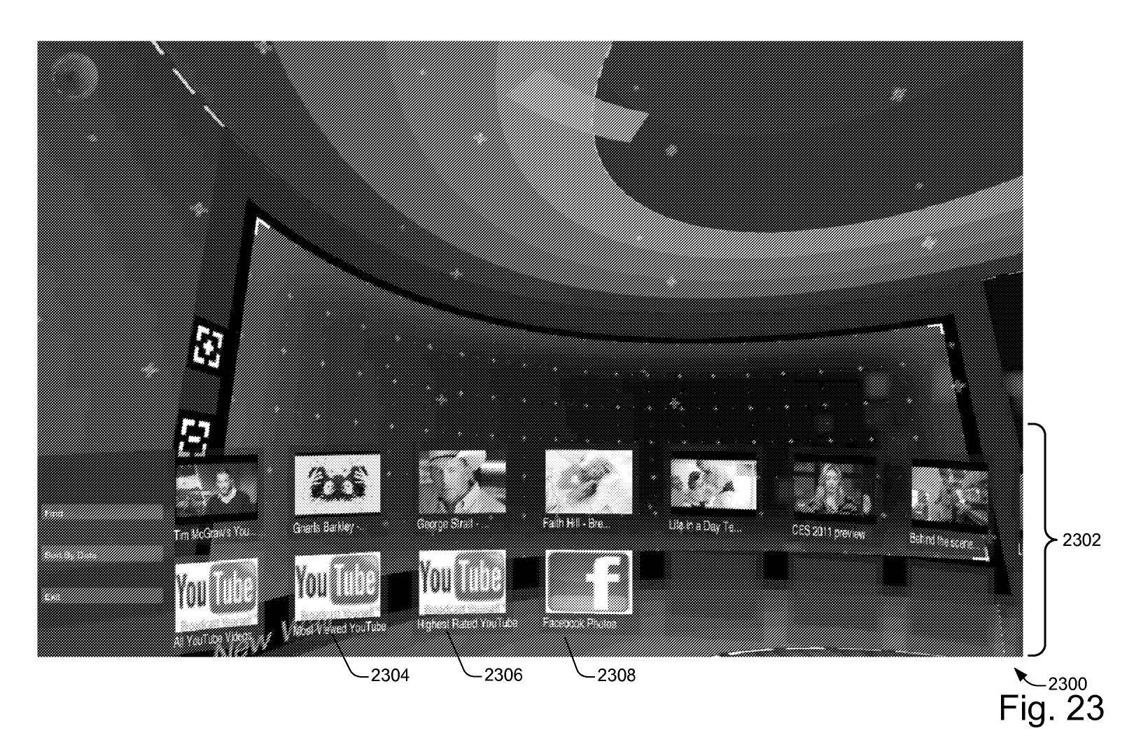

FIG. 23 shows an image 2300 of a three dimensional environment, provided in accordance with one embodiment. The image 2300 includes an embedded three dimensional halo 2302, which includes content such as content 2304, content 2306, and content 2308. The embedded three dimensional halo 2302 may display a visual representation of persistent content, suggested content, shared content, or any other type of content. The content may be displayed by moving the content onto a virtual surface such as the three dimensional sharing wall.

In some embodiments, the same three dimensional environment may be displayed on different computing devices in communication via a network. The communication may be facilitated by a server. A user of a remote computing device may be represented in the three dimensional environment by a second avatar. The users may be able to jointly interact with content, communicate, or perform other actions via the three dimensional environment.

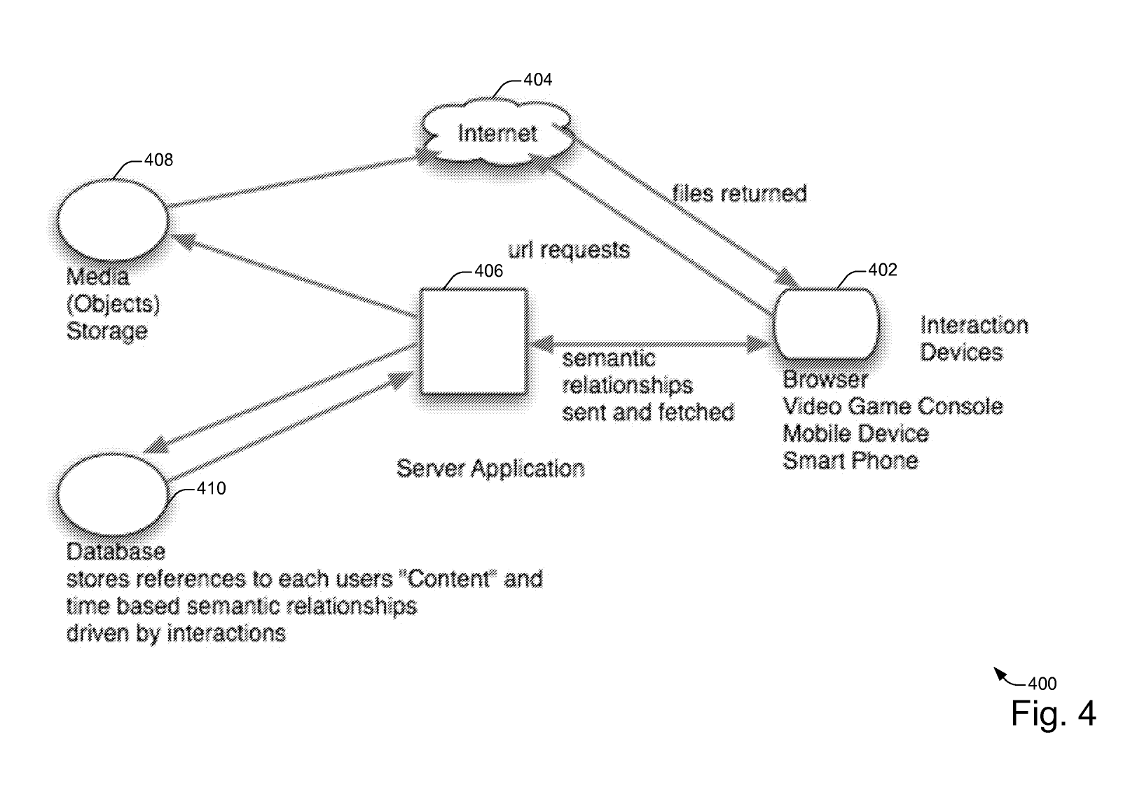

In some embodiments, a backend element may maintain a persistent storage of a user's content, metadata, halos, and other data. The persistent content and metadata may be accessible while in the environment wherever the Internet can be accessed. The backend element may include various types and numbers of servers, databases, and other computing units accessible via a network such as the Internet. Additional details of a system for providing backend functionality are discussed with respect to FIG. 4.

In some embodiments, the backend element may allow multiple users to have avatars present in the same room across a network such as the Internet. Users who are in the room may see other avatars in the room and see, share, communicate, comment on, tag, and maintain semantic relationships for content displayed in the three dimensional environment.

In some embodiments, the backend element may allow content displayed in the three dimensional environment to be made available to other users displaying the three dimensional environment from other computing devices. Content may be shared between users by dragging content displayed in the three dimensional environment from an halo or a virtual surface to another user's halo. When viewed, the thumbnail representation of content may be connected to the backend software and the actual file represented by the thumbnail may be displayed. Content may be connected to the halos by uploading it from a user's computer into the user's halo, locating content from Internet or other network sources into a user's halo, or moving content posted by another user on a virtual surface to the user's halo.

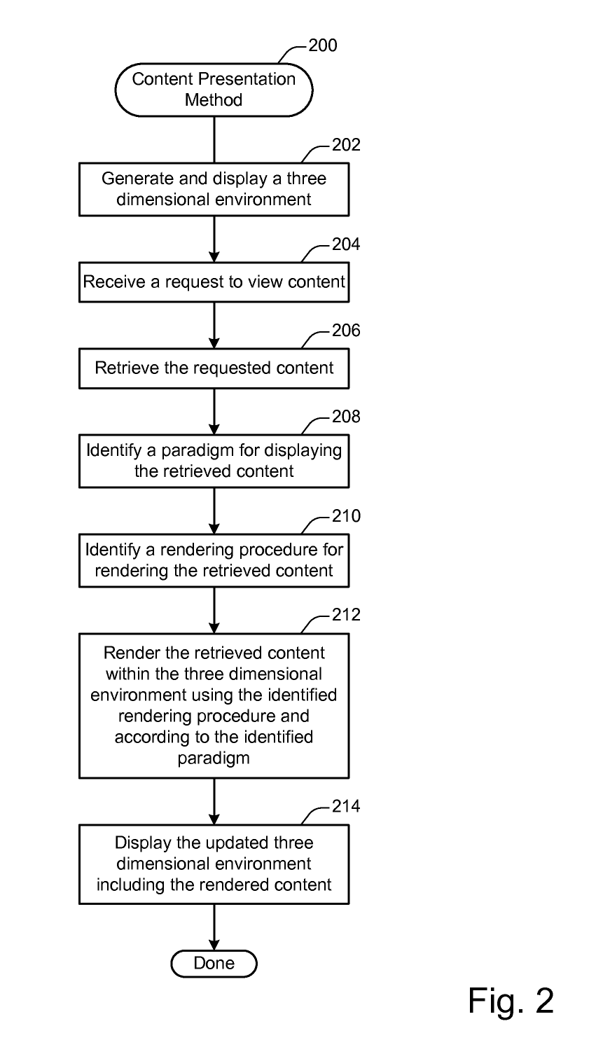

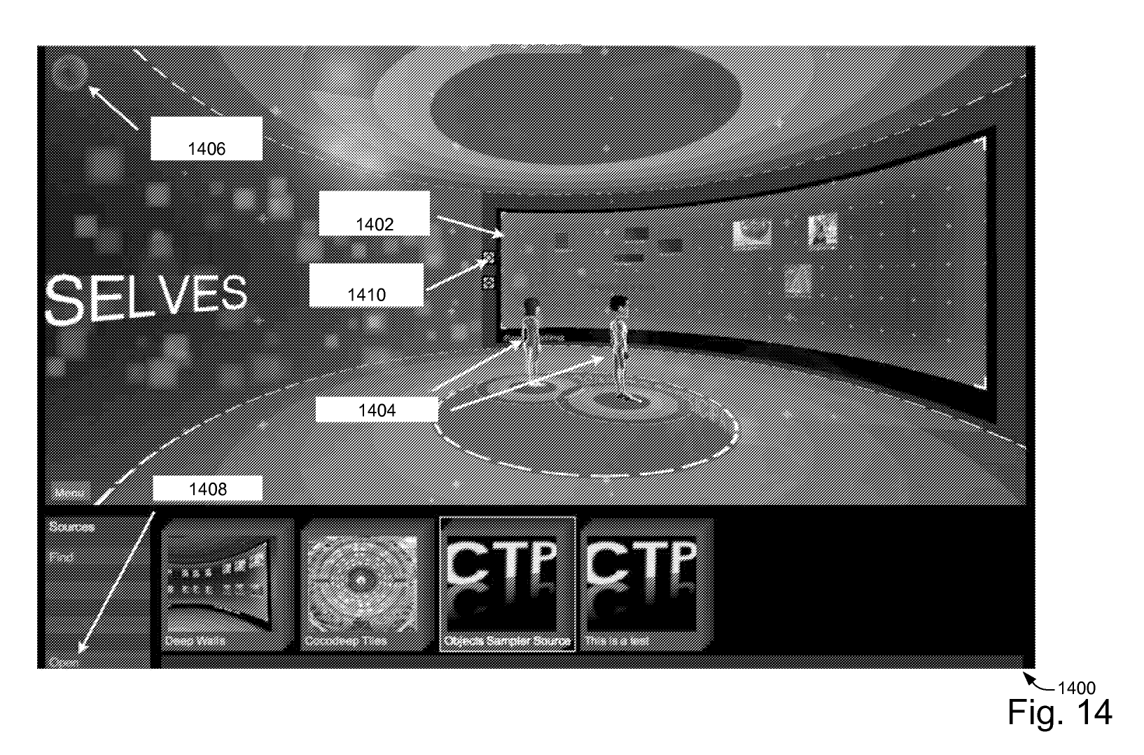

FIG. 14 shows an image of a three dimensional environment 1400, provided in accordance with one embodiment. FIG. 14 includes a virtual surface 1402, avatars 1404, a mood ring 1406, an open wall button 1408, and a save wall button 1410. As is discussed with respect to FIG. 2, the virtual surface 1402 may be used to display various types of content, such as web pages, videos, and audio files.

In some embodiments, a save element may allow a user to save the state of a wall, and an open element may allow a user to reopen a saved wall. For example, a new or previously-stored virtual surface may be opened using the open wall button 1408, and an existing virtual surface may be saved using the save wall button 1410. As another example, a wall saved to an halo may be opened by dragging a thumbnail image from the halo to a wall displayed in the three dimensional environment. A saved wall may have the content and links to content that were on the original wall. Users may group content together in relevant collections, save and recall those collections, allow other users to view or make copies of those collections, and/or allow other users to expand on those collections of content. In some embodiments, users may add tags to content.

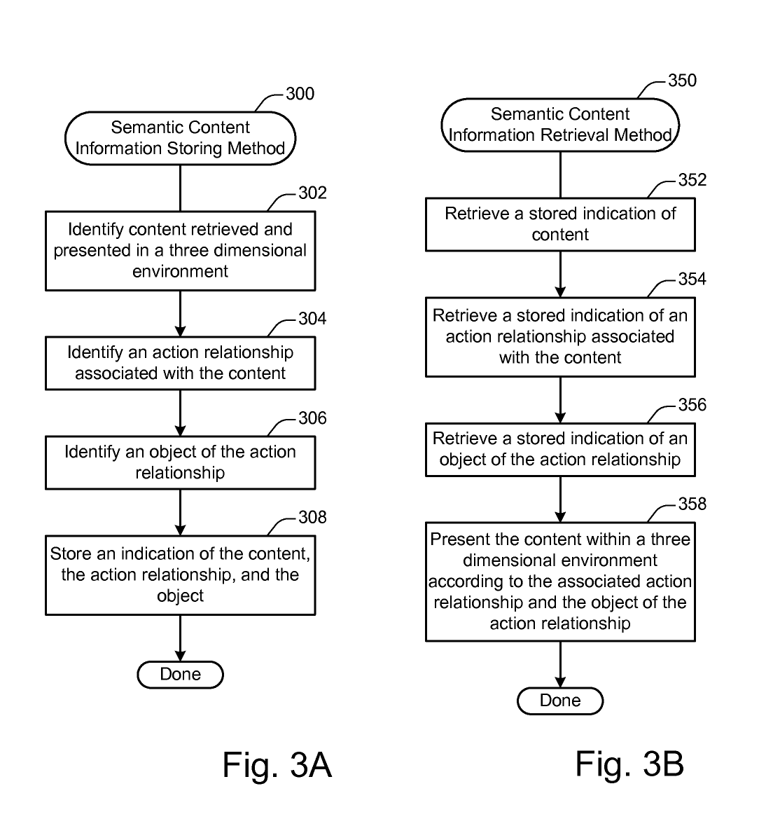

In some embodiments, opening a wall may trigger the semantic content retrieval method 350 shown in FIG. 3B, while saving a wall may trigger the semantic content storage method 300 shown in FIG. 3A.

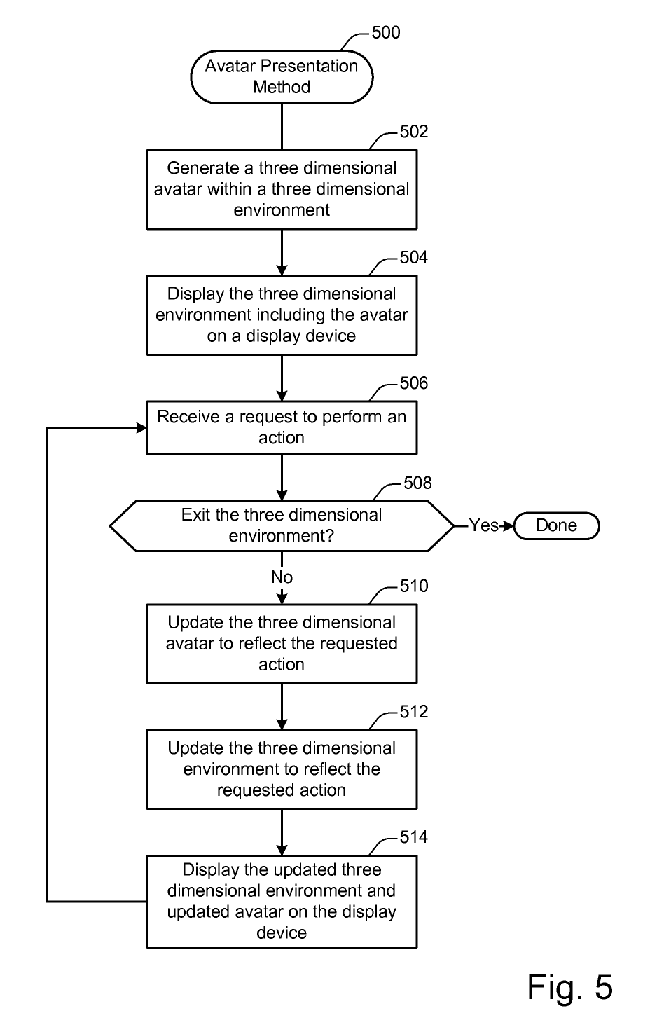

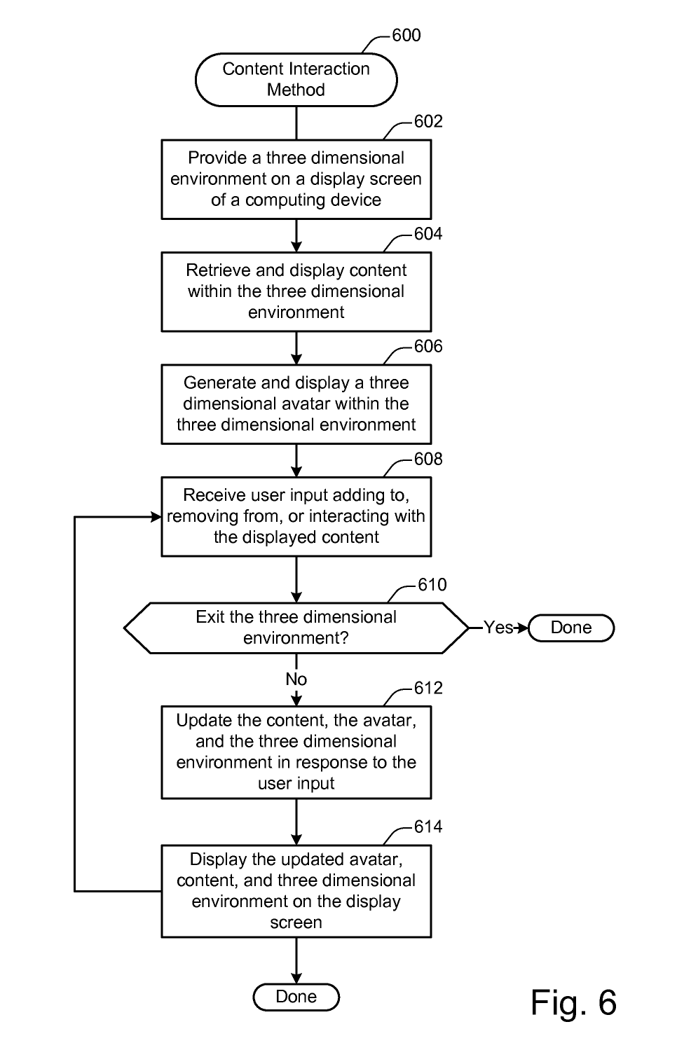

In FIG. 14, the avatars 1404 represent different users who are jointly interacting with the content displayed on the wall. Each of the users can interact with the content via the avatars. Avatar interaction with content is discussed in further detail with respect to FIGS. 5 and 6.

In some embodiments, the mood ring 1406 may display a selected mood for the avatar of the user of the local computing device and/or allow the user to select a different mood. The mood ring may be used to connect an avatar's emotions to content being viewed in the room. The mood ring may allow an avatar to be assigned a mood such as excited, happy, impatient, or sad. After being assigned a mood, the avatar may adopt one or more poses or gestures that represent the mood. Thus, the mood ring may be used to demonstrate an emotional response to the content shown, the chat content, or a general mood.

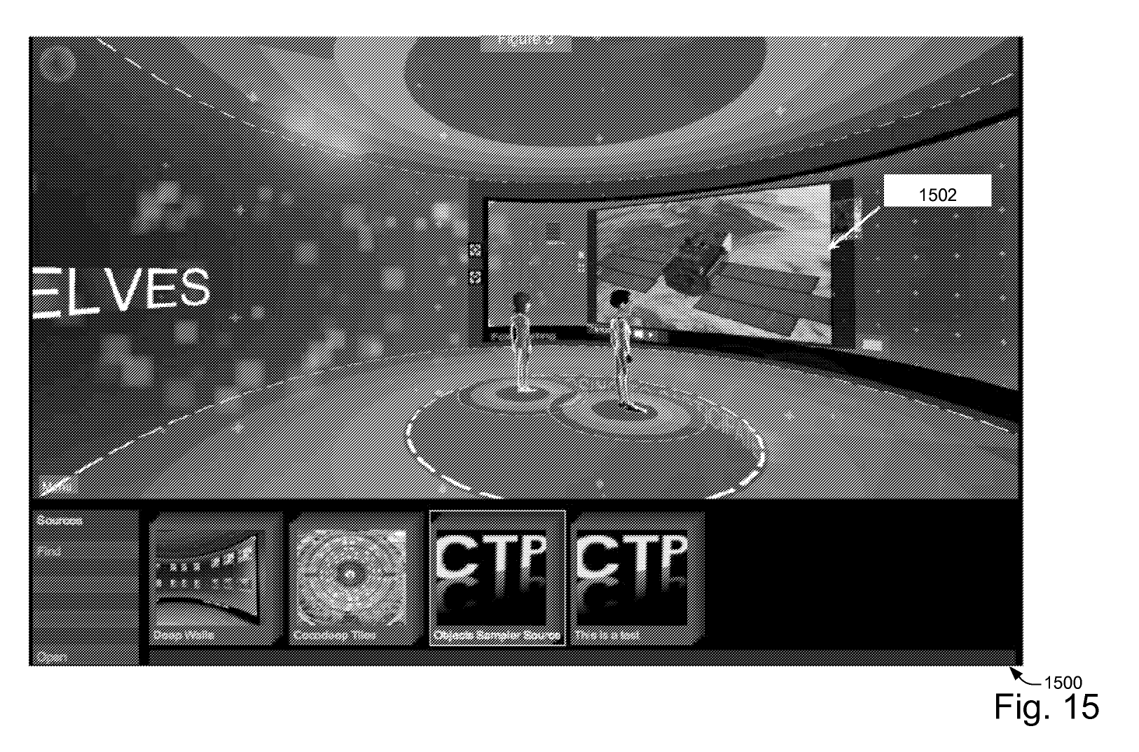

FIG. 15 shows an image of a three dimensional environment 1500, provided in accordance with one embodiment. The three dimensional environment 1500 includes a two dimensional viewing area 1502. The two dimensional viewing area 1502 may allow the user to display large, presentation size versions of content such as documents, audio files, video files, or three dimensional graphical objects represented by thumbnails attached to the wall or other surface.

In some embodiments, a user may display content in the two dimensional viewing area 1502 by clicking a viewer button, clicking a thumbnail image of the content, or by some other mechanism. Using a similar mechanism, the large, presentation size view of the content may be closed.

In some embodiments, other users in the room with their avatars may be able to see the content displayed on the two dimensional viewing area 1502 on their computing devices via a network such as the Internet, regardless of these other users' physical locations.

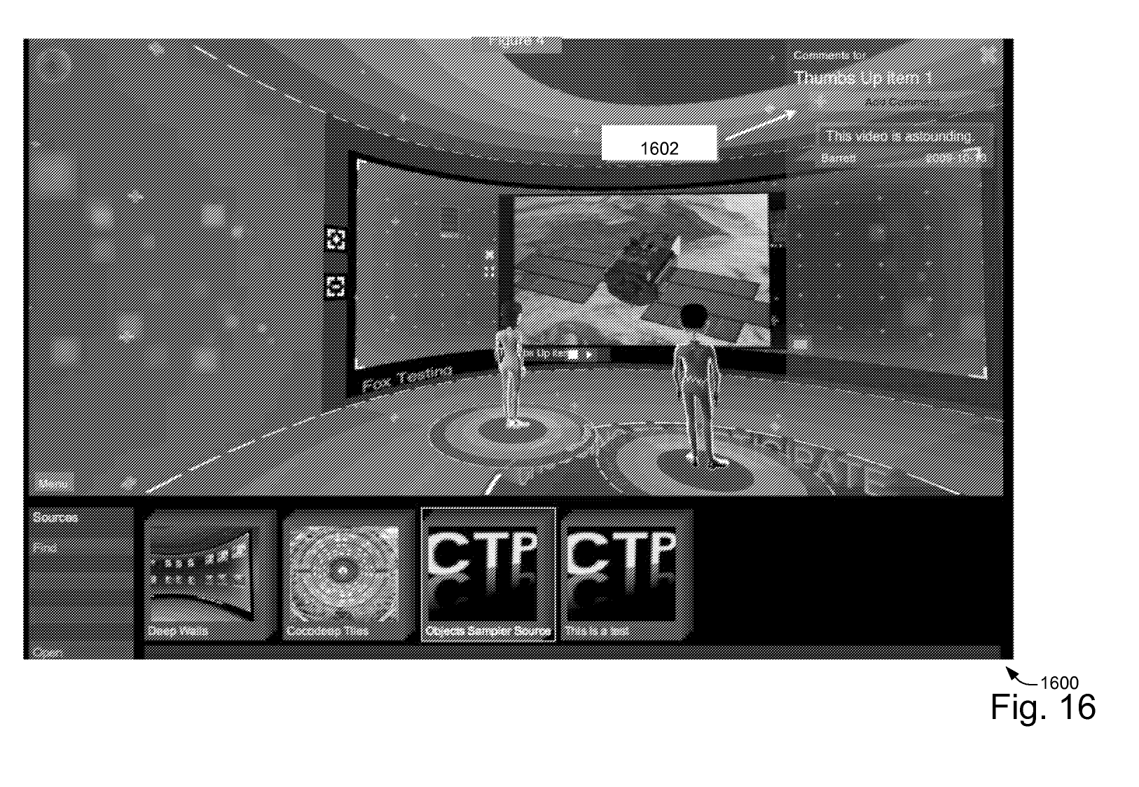

FIG. 16 shows an image of a three dimensional environment 1600, provided in accordance with one embodiment. The three dimensional environment 1600 includes a comment window 1602. In the comment window, a user can add a comment regarding the content displayed in the viewer 1502 shown in FIG. 2.

In some embodiments, users may record the interactions in the three dimensional environment over time. The interactions may be saved as content, added to a two dimensional or three dimensional halo, and/or replayed later.

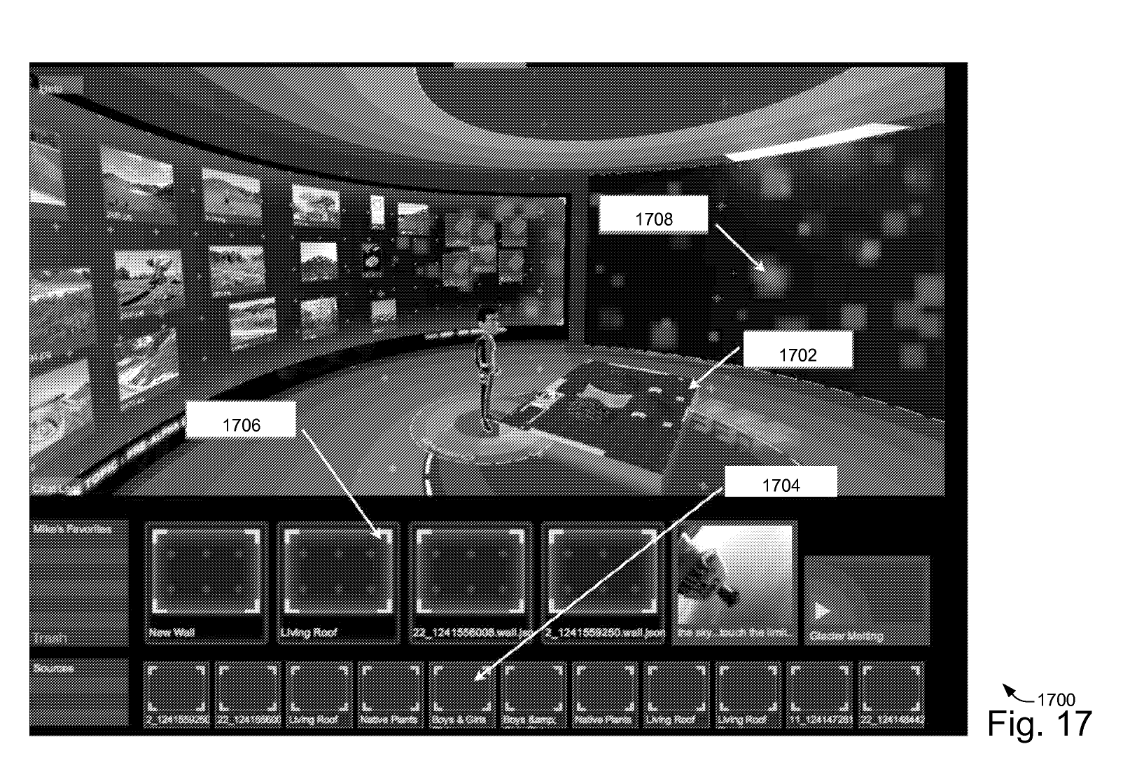

FIG. 17 shows an image of a three dimensional environment 1700, provided in accordance with one embodiment. The three dimensional environment 1700 includes a three dimensional object viewer 1702, content sources 1704, persistent content halo 1706, and particle cloud 1708.

In some embodiments, the three dimensional object viewer 1702 may be used to view three dimensional content within the room. As shown in FIG. 17, the user's avatar may be positioned around the three dimensional content displayed in the three dimensional object viewer 1702.

In some embodiments, a user can select content from a variety of sources, which may be listed in content sources 1704. For instance, sources may include public content, such as websites, RSS feeds, YouTube® channels, and Twitter® feeds. As another example, sources may include private content, such as folders on the user's computing device, content accessible via a private content repository accessible via a network such as the Internet, or music purchased at an on-line music service. As yet another example, sources may include protected or semi-private content that may be accessible to certain users based on identity. These protected sources may include shared content on YouTube®, pictures on Facebook®, content uploaded to a content management system such as Drupal™, or content shared with a limited number of other users.

In some embodiments, private or protected sources or content may automatically appear in a user's list of content sources 1704 or halo 1706. For instance, the user may log on to the three dimensional environment using a username and password for Facebook®, Google®, or another web service with a login process accessible to third party developers. When the user is logged in, the private content may be made available. In some embodiments, a single sign-on technique may be used to store credentials for various services so that a user need only log on once to access a variety of private and protected content sources.

In some embodiments, a user's information travels with the user and is not tied to a particular computing device. As discussed with respect to FIGS. 3A-4, content and indications of content may be stored on a server. When the user loads the three dimensional environment on different computing devices, these computing devices may access the server to retrieve the content and the indications of the content.

In some embodiments, the persistent content 1706 may include any content accessible on an ongoing basis, such as content labeled by a user as a favorite or content that has been repeatedly accessed within the three dimensional environment.

In some embodiments, the room sits or floats in the overall three dimensional space provided by the three dimensional environment. The room may be at least partially surrounded by an cloud-like representation of data, such as particle cloud 1708. This cloud may represent any sort of data visualization, such as search results, other users participating in their own three dimensional environments, advertisements, or related content. In some embodiments, the user may navigate the particle cloud 1708 by walking the avatar through the particle cloud, by moving the vantage point used to display the three dimensional environment through the particle cloud, or by some other technique.

In some embodiments, a user may search for additional content. For example, the user may search a local storage device or a network such as the Internet. Content located by searches may be placed in an halo and/or on a virtual surface in the three dimensional environment. Search results may be displayed in lists, on the wall, or in three dimensional object thumbnail clouds such as particle cloud 1708 that appear in the space around the room or in the center of the room.

In some embodiments, the particle cloud 1708 may include any sort of ambient information displayed in any fashion. For example, the particle cloud 1708 may display as smoke, lights, lasers, particles, or other physical phenomena. The particle cloud 1708 may be static or may be moving. The particle cloud may change by becoming faster, slower, brighter, dimmer, more dense, or less dense in response to changes in the ambient data that defines the particle cloud.

In some embodiments, the three dimensional environment may be accessed via a touch screen device. Using a touch screen device, user interaction with the three dimensional environment may be performed through the interface such that finger touch interactions perform the control of the interface, the avatar, and other functions of the three dimensional environment. The touch screen device may be located on a personal computer, laptop, smart phone, tablet, or any other type of device.

In some embodiments, the three dimensional environment may be accessed via a video game console and controlled with video game console controllers. The video game console may be capable of accessing the internet. A video game player may be able to exit a game and access the player's content in the three dimensional environment as if it were a video game.

In some embodiments, the three dimensional environment may be used in a variety of contexts and configurations where content is to be presented or where multiple people interact or collaborate with the content. For example, the three dimensional environment may be used as an education environment for presenting material or hosting a class with students as characters in the three dimensional space. Curriculum can be the content in the sources or on walls that have been previously built by the teacher. Students can comment, chat in a discussion about the content on the wall and then save the experience for later reference. As another example, scientists, architects, or engineers may use the three dimensional environment to view two dimensional content or three dimensional models in a collaboration with other scientists to discuss and interact with the content. As yet another example, media companies that own or manage music or movie content can create portal websites based on the three dimensional environment. Users may enter these portal websites and interact with the media presented there.

In some embodiments, the three dimensional environment may allow complex social interactions with data. For example, students may collaborate to solve three dimensional educational puzzles, users may arrange and comment on film clips on a virtual surface to create a documentary, software developers may use the virtual surfaces and three dimensional modeling to visualize and collaborate on software development, avatars may walk through three dimensional scatter plots or other graphs, avatars may walk around or through telemetry data or thermodynamic animations, users may label or comment on portions of complex animations or three dimensional movies, avatars may walk out of the room into a model of the body or the neurons in a brain, avatars may represent users at a virtual conference in a series of virtual conference rooms, avatars may represent students in a virtual classroom, etc.

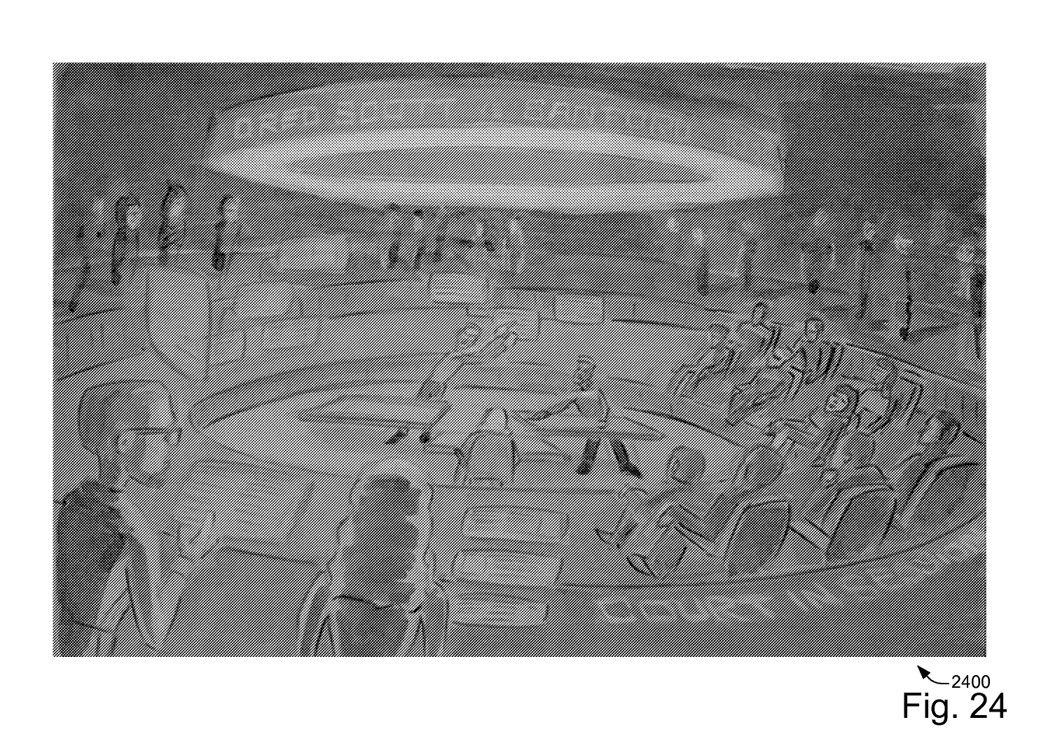

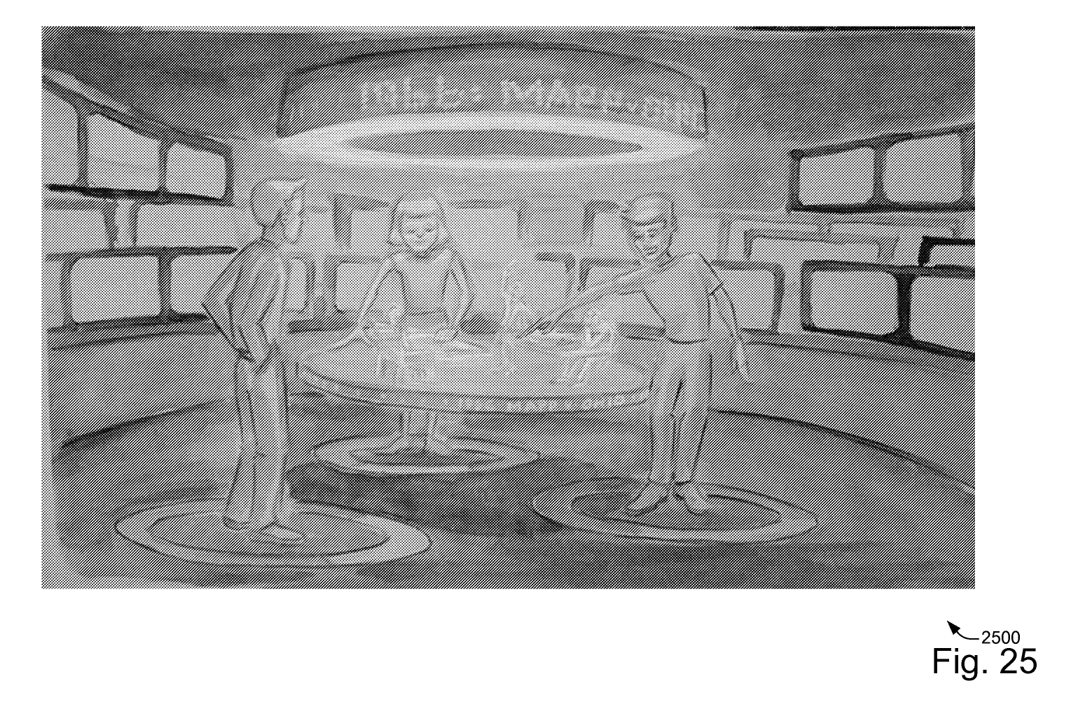

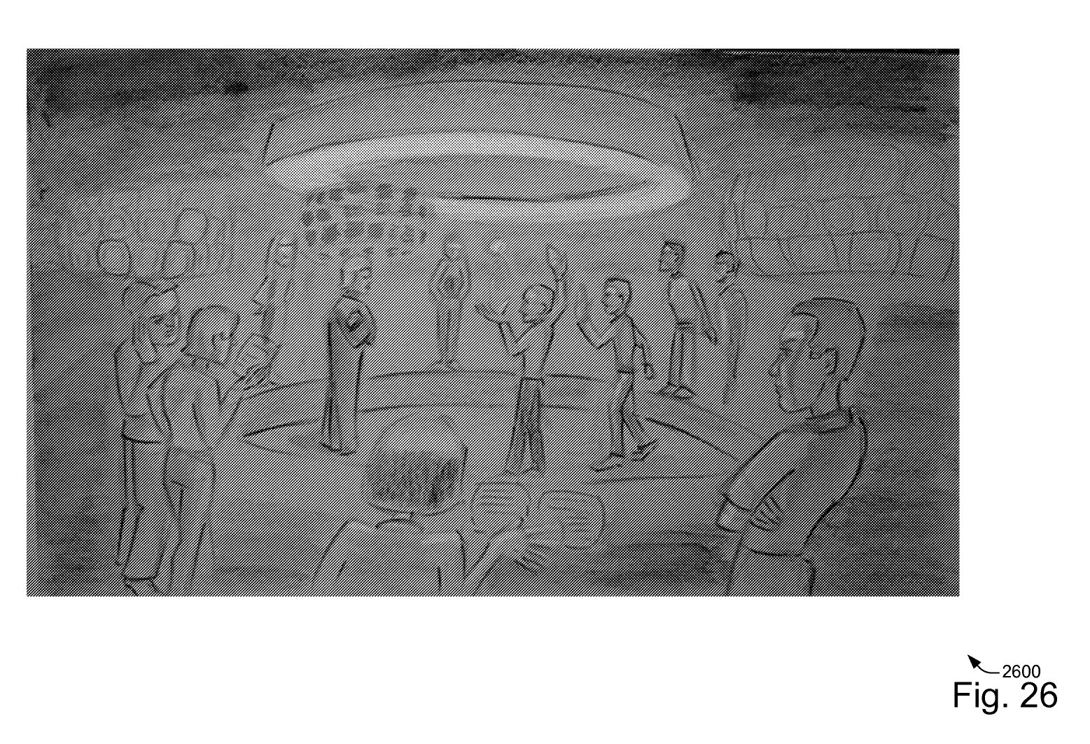

FIGS. 24-26 show images 2400, 2500, and 2600 of three dimensional environments, displayed in accordance to one embodiment. In FIG. 24, some virtual characters displayed in the three dimensional environment are reenacting the Supreme Court case Dred Scott v. Sanford, while other virtual characters observe the reenactment and view their content. In FIG. 25, three virtual characters displayed in the three dimensional environment are observing and interacting with a three dimensional video of a different three dimensional action displayed in a three dimensional content viewing area. In FIG. 26, many virtual characters are socializing, viewing content, and sharing content while sharing a virtual space. FIGS. 24-26 illustrate some of the complex social and content-based interactions that may occur using the three dimensional environment, according to one or more embodiments.

In some embodiments, a three dimensional model may be rescaled. For instance, a three dimensional model of a garden may be rescaled so that a user's avatar is the size of a tree, a blade of grass, or a single molecule. Users may navigate three dimensional models and attach content to different areas of the three dimensional models. In this way, three dimensional models may become a record of conversations between users.

In some embodiments, the three dimensional environment may function as a fully interactive video game-style environment in which avatars may interact with a wide variety of objects within the three dimensional environment. For example, users may enter a virtual world through their avatars and interact with objects in the virtual world, all while retaining access to their content and content sources.

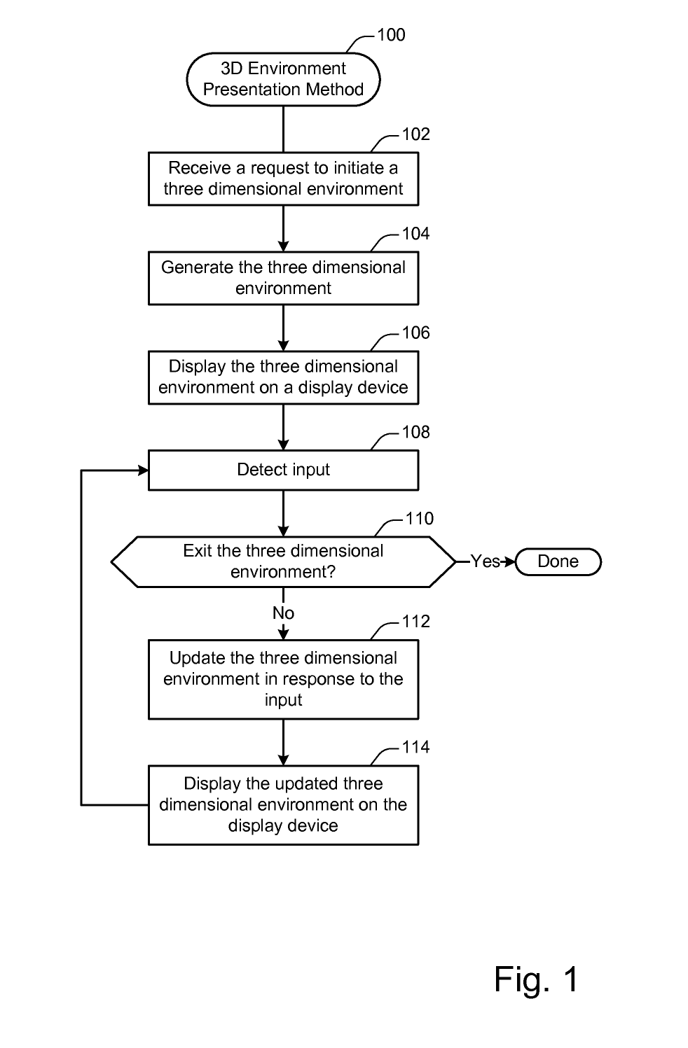

FIG. 1 shows a flow diagram of a method 100 for presenting a three dimensional environment, performed in accordance with one embodiment. In some embodiments, the method 100 may be performed at a computing device on which the three dimensional environment is presented. Alternately, the method 100 may be performed at least in part on a different device, such as a remote computing device accessible via a network. In some embodiments, the method 100 may be performed in conjunction with other methods, such as the methods shown in FIGS. 2-3B and 5-7.

At 102, a request to initiate a three dimensional environment is received. In some embodiments, the three dimensional environment may be displayed in web browser. Accordingly, the three dimensional environment may be initiated by pointing the web browser to a URI associated with the three dimensional environment. Alternately, or additionally, the three dimensional environment may be displayed in a stand-alone application. In this case, the three dimensional environment may be initiated by starting the stand-alone application.

At 104, the three dimensional environment is generated. In some embodiments, the three dimensional environment may be generated at least in part by using an existing three dimensional rendering framework or toolset. For instance, the Unity3D video game engine or another video game rendering framework may be used to generate the three dimensional environment.

In some embodiments, the three dimensional environment may be rendered using three dimensional graphics acceleration features on the computing device, as is done with many video games. In this case, the three dimensional environment may be generated with limited communication with a server.

In some embodiments, generating the three dimensional environment may include one or more operations for providing a customized appearance of the three dimensional environment.

In some embodiments, information regarding previously-accessed content may be retrieved. This content may then be displayed in the three dimensional environment. In some instances, the information regarding previously-accessed content may include semantic information describing semantic relationships between previously-accessed content and various objects within the three dimensional environment. The display of content and the handling of semantic content information are discussed in additional detail with respect to FIGS. 2-4.

In some embodiments, information regarding a user's avatar may be retrieved. The information regarding the user's avatar may include information identifying an appearance, a location, or an orientation of the user's avatar. The display and interaction of avatars within the three dimensional environment is discussed in greater detail with respect to FIGS. 5-7.

In some embodiments, information regarding a configuration or setting for displaying the three dimensional environment may be retrieved. For instance, a configuration may specify that the three dimensional environment should be displayed with a particular background, or that the three dimensional environment should be displayed with a particular size or orientation. As another example, a setting may specify a color scheme or surface arrangement of the three dimensional environment.

To display the three dimensional environment, the information retrieved for providing a customized appearance of the three dimensional environment may be combined with standardized instructions to generate the customized three dimensional environment. The generated three dimensional environment may act as a simulated, virtual three dimensional environment that can be manipulated and viewed from different vantage points. In order to display the three dimensional environment on a display screen, the generated three dimensional environment may be positioned with respect to a particular vantage point. The vantage point may provide a perspective from which the generated three dimensional environment may be viewed. In some embodiments, the vantage point may be adjustable by a user via user input.

At 106, the three dimensional environment is displayed on a display device. In some embodiments, the display device may include a flat display screen such as that often used on laptop computers, desktop computers, smart phones, tablet computers, and other computing devices. In this case, the three dimensional environment may need to be rendered as a two dimensional image for display on the two dimensional display device. Rendering the three dimensional environment may be performed at least in part by the framework used to generate the three dimensional environment. Rendering the three dimensional environment is analogous to taking a two dimensional photo of the three dimensional environment from a particular vantage point.

In some embodiments, the display device may be capable of displaying an image in three dimensions. For example, the display device may include stereoscopic glasses, a three dimensional display screen, or other three dimensional display technology. In this case, the operations of displaying the three dimensional environment may be strategically selected based on the three dimensional display technology being used. For instance, in the case of stereoscopic glasses, a two dimensional image may be rendered from two different vantage points.

At 108, input is detected. The input detected at 108 may include any input that may cause the appearance of the three dimensional environment to change. The input may trigger a change in the content displayed in the three dimensional environment, an avatar displayed in the three dimensional environment, or the three dimensional environment itself. The input that may be received at 108 is discussed in greater detail with respect to FIGS. 2-3B and 5-7.

In some instances, the input may include user input received via a user input device. For example, the input may include tactile gestures detected on a touch pad, motion or clicking detected at a computer mouse, or key presses detected at a keyboard input. As another example, the input may include physical gestures detected via a user input device having this capability, such as the Kinect® game console available from Microsoft, Inc., of Redmond, Wash.

In some instances, the input may include communications received via a network such as the Internet. For example, a remote computing device associated with a remote user may send input affecting the display of the three dimensional environment through the network. As another example, a server configured to provide backend functionality for generating the three dimensional environment may transmit input to the computing device on which the three dimensional environment is displayed.

In some instances, the input may be automatically generated by computing programming instructions being performed at the local computing device used to generate the three dimensional environment. For example, input causing the three dimensional environment to be updated may be generated automatically based on a triggering event, such as the occurrence of a particular point in time, the uploading or downloading of content, or any other triggers.

A determination is made at 110 as to whether to exit the three dimensional environment. The determination made at 110 may be based at least in part on the input detected at 108. For example, user input navigating to a different web page or closing the application in which the three dimensional environment is provided may have been detected.

If it is determined that the three dimensional environment is to be closed, one or more operations may be performed prior to closing the three dimensional environment. For example, information describing the state of the three dimensional environment may be stored so that the three dimensional environment may be recreated later. The stored information may include information regarding content displayed in the three dimensional environment, an appearance of a user's avatar, chat history, or any other information. A method of storing semantic content information according to one embodiment is described with respect to FIG. 3B.

At 112, the three dimensional environment is updated in response to the input. In some embodiments, updating the three dimensional environment may include any operations for altering an appearance or location of an avatar, adding content to or removing content from the three dimensional environment, showing user interaction with content, moving or otherwise adjusting content, displaying communications between users, displaying system messages or other types of communications, or any other actions that may occur within the three dimensional environment.

At 114, the updated three dimensional environment is displayed on the display device. The updated three dimensional environment may reflect the changes made at 112. Otherwise, the display of the updated three dimensional environment may be substantially similar to the original display of the three dimensional3 discussed with respect to operation 106.

As shown in FIG. 1, the user may continue to interact with the three dimensional environment until the three dimensional environment is closed. User interaction with the three dimensional environment, the display of content within the three dimensional environment, collaboration within the three dimensional environment, and the storage and retrieval of semantic content information are examples of actions that may be performed while the three dimensional environment is displayed. These and other actions are discussed with respect to FIGS. 2-7.

FIG. 2 shows a flow diagram of a method 200 for presenting content, performed in accordance with one embodiment. In some embodiments, the method 200 may be used to display content in a three dimensional environment.

At operation 202, a three dimensional environment is generated and displayed. In some embodiments, the three dimensional environment may be generated and displayed using the three dimensional environment presentation method 100 shown in FIG. 1. The generated three dimensional environment may be displayed on a display screen of a computing device. Images of a three dimensional environment that may be displayed in one or more embodiments are shown in FIGS. 8-22.

A request to view content is received at operation 204. The types of content that may be viewed via the three dimensional environment may include, but are not limited to: web pages, images, documents, videos, audio files, three dimensional models, graphs, and charts.

In some embodiments, the request to view content received at operation 204 may be received after the three dimensional environment is generated and displayed. Alternately, or additionally, a request to view content may be received prior to displaying and/or generating the three dimensional environment. For example, receiving a request to view content may initiate the content presentation method 200.

In some embodiments, the request to view content may be received from a user. For example, a user may provide an indication of content that the user wishes to view. The user may provide an indication of content via a user input mechanism associated with the computing device, as discussed with respect to operation 110 shown in FIG. 1.

In some embodiments, the request to view content may be automatically generated. For example, the three dimensional environment may automatically display content that was previously displayed for or selected by a user, content that was automatically selected based on user preferences, advertisements, content based on the user's identity, or any other type of content.

In some embodiments, the request to view content may be received from a server. For example, the computing device may communicate with a remote server that stores indications of content for the user, recommends or provides content for the user, and/or retrieves content for the user. Techniques for storing and retrieving content at a server are discussed with respect to FIGS. 3A-4.

The requested content is retrieved at operation 206. The operation performed at 206 may depend on where the content is stored. For instance, the requested content may be stored locally on a storage device associated with the computing device used to generate the three dimensional environment. In this case, the requested content may retrieved from the local storage device. Alternately, the requested content may be stored remotely on a server or other remote computing device accessible via a network. In this case, the requested content may be retrieved by accessing the server via the network.

At operation 208, a paradigm for displaying the retrieved content is determined. In some embodiments, content may be displayed within the three dimensional environment according to various paradigms. These paradigms may include, but are not limited to, a virtual surface within the three dimensional environment, an external three dimensional visualization area that may be viewed from without, an immersive three dimensional visualization area that may be viewed from within, or some combination thereof.

In some embodiments, the three dimensional environment may include one or more virtual surfaces for displaying content. For example, FIG. 8 shows a drawing of a three dimensional environment 800. The three dimensional environment 800 includes a wall 802, a wall 804, and a wall 806. The walls 802, 804, and 806 are examples of virtual surfaces on which content may be displayed. In FIG. 8, information related to Twitter® is shown on wall 802, while information related to Facebook® is shown on wall 806. The wall 804 includes a video portion 808, video controls 810a, 810b, 810c, and 810d, and audio playback area 812. As shown in FIG. 8, various types of content may be displayed on virtual surfaces within the three dimensional environment.

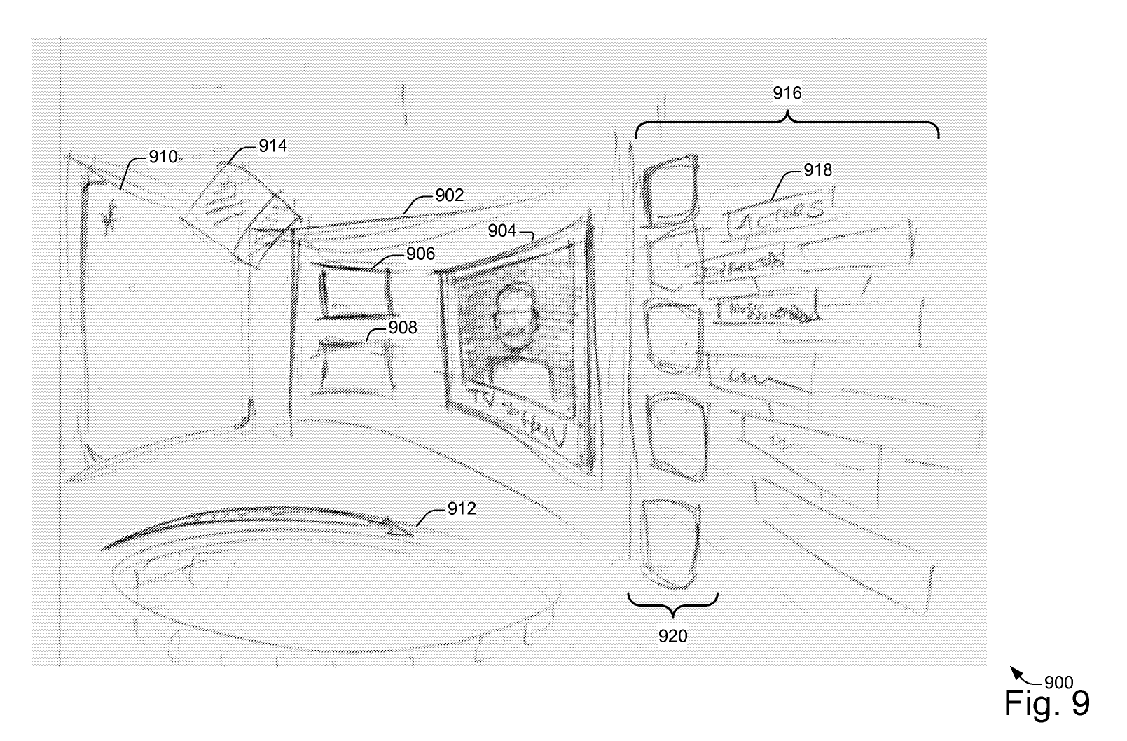

Another example of the use of virtual surfaces to display content is shown in FIG. 9, which shows a drawing of a three dimensional environment 900. The three dimensional environment 900 includes a wall 902, a wall 910, and a wall 916. A TV show 904 and related content 906 and 906 are displayed on the wall 902. Bibliographic information 918 identifying actors and directors for the TV show 904 is displayed on the wall 916, which also displays additional related information 920.

In some embodiments, virtual surfaces may be displayed in various orientations. A virtual surface may appear as a wall in the three dimensional environment, as shown in FIG. 8. Alternately, a virtual surface may appear as a floor, a ceiling, a raised platform, or as a surface in any other type of orientation.

In some embodiments, a virtual surface may be flat. Alternately, a virtual surface may be curved. For example, the content shown in FIG. 8 is displayed on curved walls 802, 804, and 806. In the case of a curved virtual surface, flat two-dimensional content may be transformed to appear as curved to better fit the curved virtual surface. Alternately, flat two-dimensional content may simply be arranged over the curved virtual surface.

In some embodiments, the three dimensional environment may include one or more external three dimensional visualization areas that may be viewed from without. For example, FIG. 9 shows a drawing of a three dimensional environment 900 that includes a three dimensional visualization area 912. Above the three dimensional visualization area 912 is shown a three dimensional solid 914.

The three dimensional solid 914 may be viewed externally by a user. That is, the three dimensional solid 914 may be viewed from outside the three dimensional solid 914 from various perspectives. In some embodiments, the three dimensional solid 914 may be rotated, expanded, contracted, or otherwise altered within the three dimensional environment. Alternately, or additionally, the three dimensional environment may appear to move around or with respect to the three dimensional solid 914.

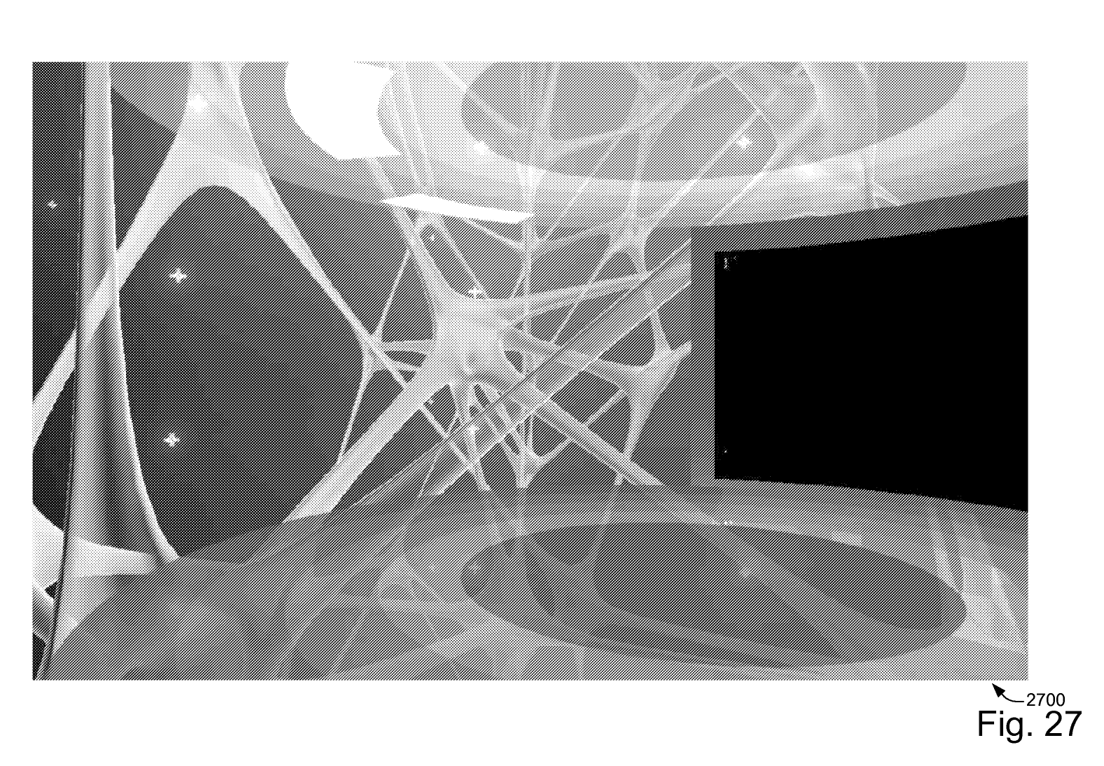

In some embodiments, the three dimensional environment may include one or more external three dimensional visualization areas that may be viewed from within. For example, FIG. 27 shows an image of a three dimensional environment in which the conversation deck is surrounded by a three dimensional model of neurons. Avatars displayed in the three dimensional environment may be able to move out into the space around the deck to interact with and explore the three dimensional model. The vantage point of the viewer may move with the avatars or independent of the avatars. The three dimensional model may be tagged, stored, or linked with other content. Various kinds of three dimensional models may be displayed and interacted with in this fashion.

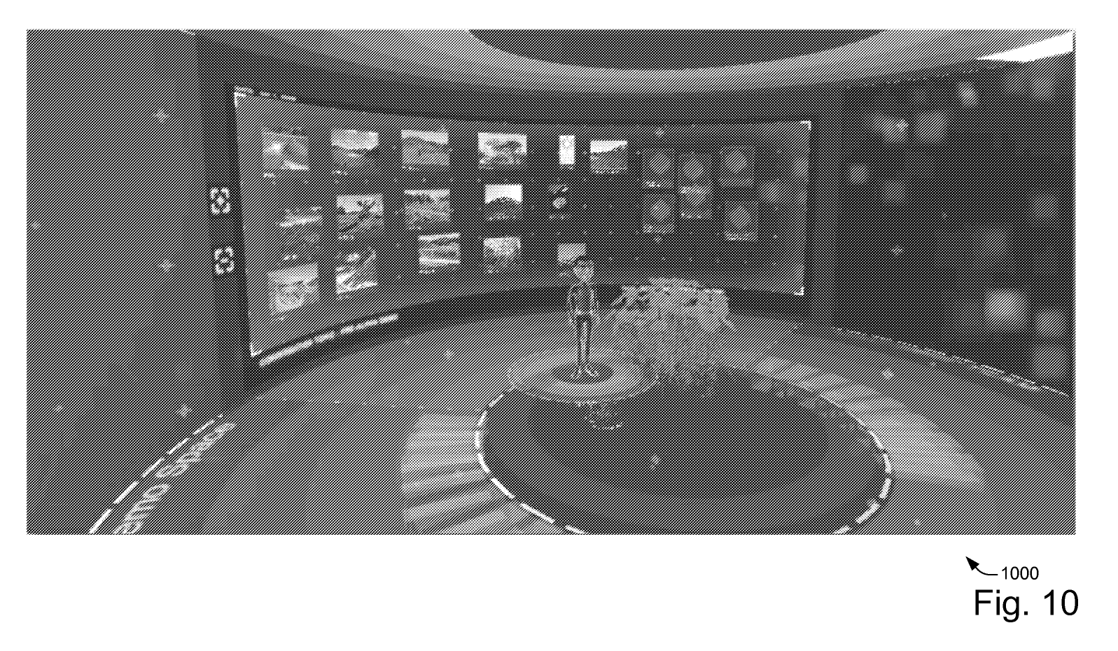

In some embodiments, more than one paradigm may be used at a given time to display content. For example, FIG. 10 shows an image of a three dimensional environment in which content is displayed according to several different paradigms. At the rear of the three dimensional environment, images are displayed on a curved surface. In the center of the three dimensional environment, flowering plants are displayed in an external three dimensional visualization area that may be viewed from without. In the background of the three dimensional environment, blocks are displayed that may represent a data visualization such as other users who are participating in the three dimensional environment.

In some embodiments, the paradigm for displaying the requested content may be identified automatically. For instance, two dimensional content may be automatically displayed on a virtual surface, while a three dimensional model may be automatically displayed in an external three dimensional visualization area.

In some embodiments, the paradigm for displaying the requested content may be identified or selected by the user. For example, the user may indicate that the content should be displayed on a virtual surface or in an external three dimensional visualization area.

At 210, a rendering procedure for rendering the retrieved content is identified. The rendering procedure may include any web browsers, audio and/or video compression or decompression methods, document readers, or other software utilities for rendering the retrieved content.

In some embodiments, the rendering procedure may be identified automatically. For example, web pages may be automatically rendered using a web browser, while Personal Document Format (PDF) documents may be automatically rendered using a PDF reader. Two dimensional or three dimensional content may be associated with a file type used to identify a rendering procedure for the content.

In some embodiments, the rendering procedure may be selected by a user. For example, the user may identify a software utility for rendering the requested content or may identify a file type associated with the requested content.

At 212, the retrieved content is rendered within the three dimensional environment. The content is rendered using the rendering procedure identified at operation 210. The content is rendered within the three dimensional environment in accordance with the paradigm identified at 208. In some embodiments, the rendering of the retrieved content at 212 may be substantially similar to the updating of the three dimensional environment 112 shown in FIG. 1.

In some embodiments, the rendering procedure may act as software embedded within the three dimensional environment. For example, web browser software used to generate web pages may be embedded within the three dimensional environment so that when the user interacts with the web page, the interaction is displayed within the three dimensional environment. This interaction may include clicking links, navigating to different web pages, scrolling the web page, or performing any other webpage-related action.

In some embodiments, the content may be rendered as ambient information in the particle cloud surrounding the room. The particle cloud may be automatically updated based on a dynamic search conducted in response to user activities, based on the activity of other users in communication with the three dimensional environment system, or based on updated data.

In some embodiments, the appearance of the three dimensional environment may be updated based on the requested to view content. For example, a user may drag content onto an icon displayed in an operating system on the computing device in order to load content into the three dimensional environment for display. In this case, the content may appear to fall from the sky into the three dimensional environment.

At 214, the updated three dimensional environment including the rendered content is displayed. In some embodiments, displaying the updated three dimensional environment at 214 may be substantially similar to operation 114 shown in FIG. 1.

FIG. 3A shows a flow diagram of a method 300 for storing semantic content information, performed in accordance with one embodiment. The method 300 may be performed at a computing device via which the three dimensional environment is provided. Alternately, all or portions of the method 300 may be performed at a server in communication with the computing device.

In some embodiments, the semantic content information stored using the method 300 may include any information relating to the display of content within a three dimensional environment. For example, the semantic content information may indicate what content is displayed, how the content is displayed, where the content is displayed. By storing such information, content displayed in a three dimensional environment that is subsequently terminated may later be displayed again in the same fashion.

In some embodiments, the semantic content information stored using the method 300 may include information for ontological modeling, such as a semantic triple. A semantic triple may be a statement concerning content or other information. The semantic triple may include an instance such as content (e.g., a subject), a property that refers to that instance (e.g., a predicate), and/or a value for that property (e.g., an object).

For example, a web page may be displayed in a certain location on a particular wall (e.g., a wall belonging to a user). In this example, the web page may be the subject or instance, the wall location may be the predicate or property, and the wall may be the value or object.

As another example, a user may select a piece of content for viewing any number of times. In this example, the user may be the subject or instance, the number of times the content has been selected may be the predicate or property, and the content may be the value for that property.

At 302, content that has been retrieved and presented in a three dimensional environment is identified. In some embodiments, the content may be retrieved and presented via the content presentation method 200 shown in FIG. 2.

In some embodiments, the content may be identified by an address, location, index, or other identifier. For instance, the content may be a web page, video, or image accessible via a network such as the Internet. In this case, the content may be identified by a URI used to access the content. As another example, the content may be a document or video stored locally on the computing device used to generate the three dimensional environment. In this case, the content may be identified by a file address, database index, or other identifier used to access the content on the local machine.

At 304, an action relationship associated with the content is identified. In some embodiments, the action relationship may be any property or predicate associated with the content. For example, the action relationship may specify one or more of the following: a location (e.g., on a virtual surface) at which the content is displayed, a size of the content, an orientation of the content, a paradigm for displaying the content, a membership in a list of content, an ownership relationship, or any other action relationship information.

At 306, an indication of an object of the action relationship is identified. In some embodiments, the object of the action relationship may be any predicate or value of the property identified in FIG. 304. For example, the object of the action relationship may specify one or more of the following: a virtual wall, a user, an area for displaying three dimensional content, a group, a list of content, an organization, or any other object information.

At 308, an indication of the content, the action relationship, and the object are stored. In some embodiments, some or all of this information may be stored at a storage device accessible to the computing device used to generate the three dimensional environment. Alternately, or additionally, some or all of this information may be stored at a remote computing device such as a server accessible via a network. Additional details of the interaction between the computing device and the server are discussed with respect to FIG. 4.

FIG. 3B shows a flow diagram of a method 350 for retrieving semantic content information, performed in accordance with one embodiment. In some embodiments, the method 350 may be used to present content in a three dimensional environment in accordance with previously stored semantic content information. Some or all of the operations in the method 350 shown in FIG. 3B may be the inverse of the operations in the method 300 shown in FIG. 3A.

At 352, an indication of content is retrieved. At 354, an indication of an action relationship associated with the content is retrieved. At 356, an indication of an object of the action relationship is retrieved. Each of the operations 352, 354, and 356 may be the inverse of operations 304, 306, and 308 shown in FIG. 3A.

Depending on whether the indications of content, action relationship, and object of the action relationship are stored locally or remotely, the retrieval operations 352, 354, and 356 may be performed locally at the computing device generating the three dimensional environment, remotely at a server, or in part at the computing device and in part at the server.

Although the retrieval of the indications of content, action relationship, and object of the action relationship are shown as distinct operations in FIG. 3B, in some embodiments these operations may be performed concurrently. For example, each of these pieces of information may be transmitted from a server to a client machine in a single message.

At 358, the content is presented in the three dimensional environment according to the associated action relationship and the object of the action relationship. For example, if the retrieved semantic content information indicates that a web page should be displayed in a certain location and with a certain size on a particular wall, then the web page will be displayed in this fashion. In some embodiments, the content may be displayed using the content presentation method 200 shown in FIG. 2.

FIG. 4 shows a system diagram of a system 400 for storing and retrieving semantic content information, in accordance with one embodiment. The system 400 includes interaction devices 402, the Internet 404, a server application 406, media (objects) storage 408, and a database 410.

In some embodiments, the system 400 may be used in conjunction with the methods 300 and 350 shown in FIGS. 3A and 3B. Content specified by the semantic content information may be presented in a three dimensional environment.

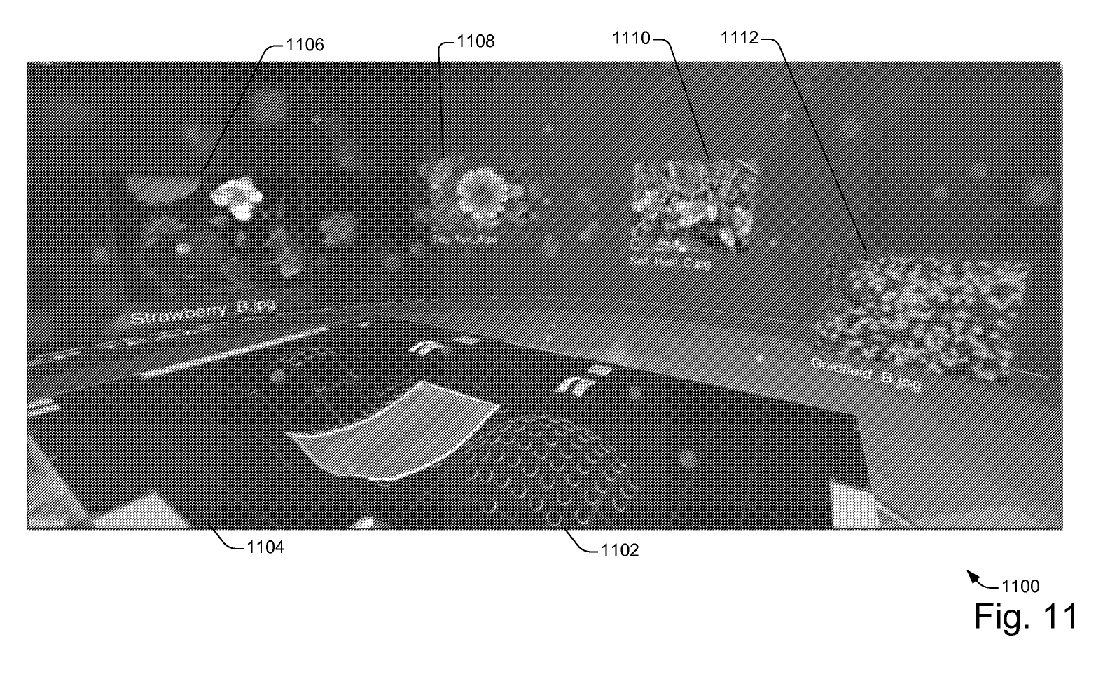

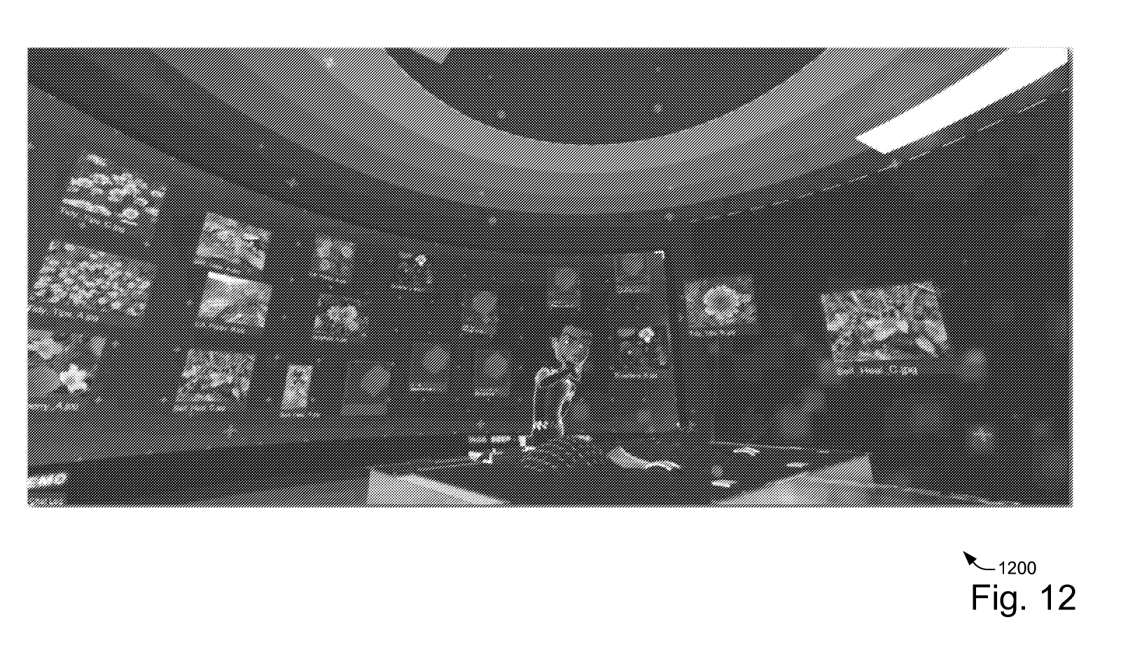

Examples of the types of content presentations that may be identified by the semantic content information are shown in FIGS. 11 and 12. FIGS. 11 and 12 show images 1100 and 1200 of a three dimensional environment. As shown in FIG. 11, a three dimensional model 1102 is displayed in a three dimensional content presentation area 1104. The three dimensional content presentation area 1104 may be associated with a user and may be viewed in conjunction with a user's avatar, as shown in FIG. 12. In this case, semantic content information may specify the content used to create the three dimensional model 1102, the mode of its display, and an identifier associated with the user or the user's three dimensional presentation area 1104.

FIG. 11 also includes images 1106, 1108, 1110, and 1112. These images are each linked to locations on the three dimensional model. Semantic content information related to these images may identify the images, a location on the three dimensional model with which the images are associated, an identifier associated with the three dimensional model or three dimensional model presentation area.

In some embodiments, as shown in FIGS. 11 and 12, content may be linked with users, content presentation areas, or other content in a variety of ways. The linkages between content and/or the content itself may be stored via the system shown in FIG. 4.

In some embodiments, the system 400 may be used to generate automatic predictions or recommendations of content for the user. The system may analyze semantic content information stored according to the semantic content information storing method 300 shown in FIG. 3A. For example, if a user has often selected for viewing web pages or images regarding chemistry, then the system 400 may suggest chemistry-related web pages or advertisements to the user. These suggestions may appear in the ambient information cloud surrounding the room within the three dimensional environment, in a list of search results, or in any other accessible group of information.

In some embodiments, the system 400 may be used to change a library of gestures that an avatar exhibits. For example, semantic content may have been stored that indicates that the user often assumes a particular emotional state when viewing a particular type of content. If this determination is made via the system 400, then the user's avatar may assume this emotional state automatically.

In some embodiments, the system 400 may be used to create search chains. For example, a user may search for content on a topic such as chemistry. Based on the user's semantic relationships stored via the system 400, the system 400 may automatically make predictions regarding related information that the user may wish to view. The user's primary search may be displayed in a primary search area such as the room itself, while the chained search information may be displayed in the ambient information particle cloud.

The interaction devices 402 may include any hardware and/or software used to present content in a three dimensional environment. For example, the interaction devices 402 may include personal computers, laptop computers, mobile devices, smart phones, video game consoles, web browsers, tablet computers, e-book readers, network-enabled televisions, holographic display devices, or any other devices.

In some embodiments, content accessible via a network may be displayed in a three dimensional environment on one of the interaction devices 402. For example, the content may be accessible via the Internet 404. This content may be downloaded, uploaded, or otherwise interacted with via the interaction devices 402. In some embodiments, the content may be presented using the content presentation method 200 shown in FIG. 2.

In some embodiments, semantic content information may be stored and/or retrieved. As discussed with respect to FIGS. 3A and 3B, semantic content information may be stored locally and/or remotely. For example, semantic relationships may be sent and/or fetched by the interaction devices 402 from the server application 406. The server application 406 may include any hardware and/or software for receiving the semantic relationships from the interaction devices, storing the semantic relationships, and providing the semantic relationships to the interaction devices.

In some embodiments, the semantic content information may be stored in a database, such as the database 410 in communication with the server application 406. The database 410 may include any hardware and/or software for storing the semantic content information.

Although the database 410 is shown in FIG. 4 as being separate from the server application 406, in some embodiments the database 410 and the server application 406 may be located in the same physical device or devices. Alternately, or additionally, the database 410 and/or the server application 406 may be distributed across a plurality of physical devices.

In some embodiments, the database 410 may store references to content that is displayed. For example, the database 410 may store references to content along with indications of the users with which the content is associated. Additionally, or alternately, the database 410 may store semantic relationships, which may be time-based. That is, the semantic relationship information stored in the database for a user may improve as the user continues to use the system over time and as the semantic relationships better reflect the user's interests and preferred content. The improvement in semantic relationships may allow the system to better suggest relevant information to the user.

In some embodiments, the server application 406 may receive media objects from the interaction devices 402. For example, a user may load local content for display in the three dimensional environment. This local content may not be accessible via the Internet, and may be accessible only via the interaction device that the user is using. In order to make this content accessible from other interaction devices, accessible during subsequent three dimensional environment sessions, and/or accessible to other users, the content may be provided to the server application 406. For example, the content may be provided to the server application 406 when storing a semantic relationship related to the content.

The server application 406 may store this uploaded content in the media storage 408. The media storage 408 may include any hardware and/or software for storing the content. For example, the media storage may include storage devices such as hard drives or flash memory devices, storage services such as cloud-based storage systems, storage systems such as a redundant array of independent disk (RAID), or some combination thereof.

In some embodiments, the stored media objects may be made accessible via a network such as the Internet 404. When a semantic relationship relating to a stored media object is retrieved by an interaction device, the stored media object can then be retrieved via the Internet 404. Thus, content that was previously local may be made remotely accessible.

In some embodiments, access to media objects stored in the media storage 408 may be limited by access control mechanisms. For example, access may be limited to the user who uploaded the content. As another example, access may be limited to a list of users specified by the owner of the content. In some embodiments, the specific access control mechanism to employ may be strategically selected based on the nature of the content being stored.

FIG. 5 shows a flow diagram of a method 500 for presenting an avatar, performed in accordance with one embodiment. An avatar is also referred to herein as a virtual character. In some embodiments, the avatar is an entity displayed within the three dimensional environment. An avatar is capable of being controlled by user input received at the computing device at which the three dimensional environment is generated or by input received from a remote computing device via a network.

An avatar may be displayed in the three dimensional environment for various reasons. The avatar may provide a user with a virtual presence within the three dimensional environment. The avatar may be used to reflect the user's moods or reaction to content. The avatar may be used to provide a sense of scale or perspective to the content displayed in the three dimensional environment. The avatar may be used to assist in navigating the three dimensional environment. The avatar may reflect actions performed by the user, such as the manipulation of content. The avatar may cause the three dimensional environment to seem game-like. The avatar may be used as a medium through which to communicate with other users of the three dimensional environment. The avatar may add to a sense of enjoyment in using the three dimensional environment.

In some embodiments, the avatar may be used to reflect the interaction of the user with content and with the three dimensional environment. For example, an avatar's three dimensional halo may appear as bright or shining when content has recently be added, and appear as dull or dim when content has not be been added for a period of time. As another example, the avatar may make hand gestures in which the avatar appears to drag content around the three dimensional environment when the user rearranges the content. The avatar may allow the three dimensional environment to be used as a communication medium in which characters displayed in the three dimensional environment represent what their controlling users are actually doing. For instance, if a user views a web page, then the avatar may appear to study the content as displayed on a virtual surface.

At 502, the three dimensional avatar is generated within the three dimensional environment. In some embodiments, the generation of the three dimensional environment at operation 502 may be substantially similar to the generation of the three dimensional environment at operation 104 shown in FIG. 1.

The avatar may be represented as a virtual three dimensional representation of a character, such as a person, an animal, an object, or a cartoon character. In some embodiments, the appearance of the avatar may be selectable and/or customizable. For example, a user may be able to select a base appearance of the avatar and then select various customizations to the appearance to the avatar. The customizable aspects of the avatar may include, but are not limited to, the avatar's skin color, hair, mood, facial expressions, gestures, eye color, body shape, face shape, clothing, and accessories. Accordingly, the generation of the avatar at 502 may include one or more operations for receiving or retrieving user selections or settings regarding the appearance of the avatar.

In some embodiments, a user may define a preferred appearance of the avatar. This preferred appearance may be stored to a server, as discussed with respect to semantic content in FIGS. 3A-4. Then, the user's avatar may appear in accordance with the preferred appearance whenever the user loads a three dimensional environment on a computing device and provides identification information to the server, regardless of whether the computing device was the original device on which the user's preferences were specified. In some embodiments, preferences or settings regarding the appearance of the three dimensional environment, such as background, color scheme, or default content to display may be specified and stored in a similar fashion.

At 504, the three dimensional environment including the avatar is displayed on a display device. In some embodiments, the display of the three dimensional environment at operation 504 may be substantially similar to the display of the three dimensional environment at operation 106 in FIG. 1.

At 506, a request is received to perform an action. In some embodiments, the request may be received as user input from a user of the computing device on which the three dimensional environment is generated. The request may define any available action that may be taken within the three dimensional environment.

In some embodiments, the request may comprise an interaction with content. The interaction with content may include adding to, removing from, sharing, moving, or altering content within the three dimensional environment. Interaction with content is described in more detail with respect to FIG. 6.

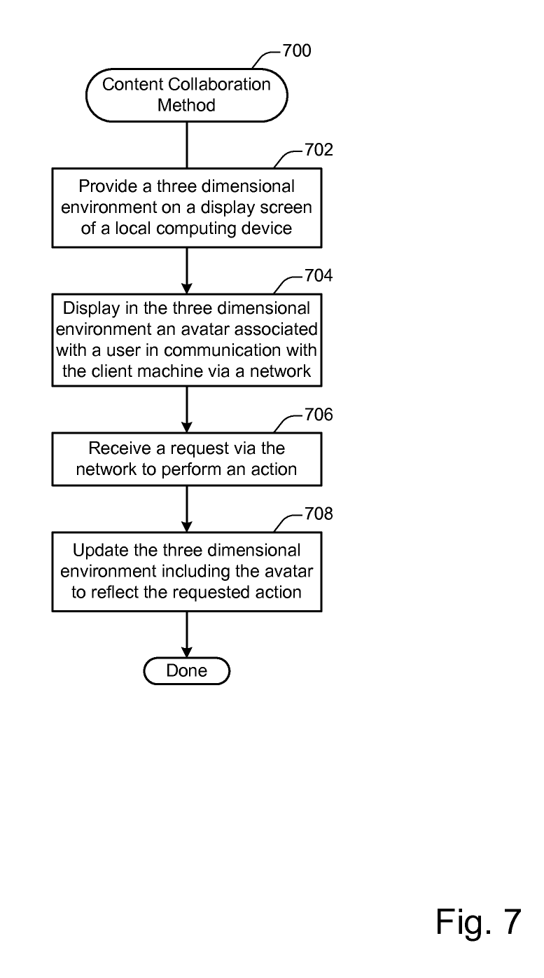

In some embodiments, the request may comprise a movement of the avatar from one location to another location. The avatar may function as a user's virtual presence within the three dimensional environment. The avatar may be moved about the three dimensional environment in order to interact with the three dimensional environment, the content displayed within the three dimensional environment, and/or the avatars of other users. Collaboration on content is discussed in greater detail with respect to FIG. 7.

For example, the avatar may be moved within or around a three dimensional model. As discussed with respect to FIG. 2, the three dimensional environment may display three dimensional models that may be viewed from outside the models, from inside the models, or both. The avatar, as well as the vantage point from which the three dimensional environment is displayed, may be moved between these various points. In some embodiments, three dimensional models may be enlarged or reduced in size. If changes in size occur, then the avatar may appear to reduce or increase in size in relation to the three dimensional model. One example of where such types of motions might occur is in the case where the user is controlling the avatar and is viewing a three dimensional model of a molecule. The user might move the avatar around the molecule, perhaps while discussing the molecule with other users. The user might also enlarge the molecule and move the avatar to focus on a single atom or atomic bond. Thus, the user's avatar may be used to navigate the three dimensional environment and to provide a sense of size and scope to the content displayed therein.

As another example, the avatar may be moved with respect to other avatars. For instance, the three dimensional environment may display many remote avatars, with each remote avatar associated with a different user at a respective computing device in communication via a network with the computing device used to generate the three dimensional environment. The user may move the user's avatar from one group of the remote avatars to another to create an appearance of locality in the interaction. In some embodiments, the behavior of the three dimensional environment may change in response to the location of the avatar. For example, if many avatars are displayed in the three dimensional environment, the chats displayed to the user may be filtered according to the locality of the avatars. That is, the user may choose to chat primarily with other users whose avatars are located in proximity to the user's avatar. In this way, interaction between avatars within the virtual room displayed in the three dimensional environment may approximate conversations in a real room.

In some embodiments, the avatar may be assigned a different emotional state. The emotional state of an avatar is also referred to herein as a mood. The emotional state may be selected to react to content, other users, or a general mood. The avatar may reflect the selected mood by displaying facial expressions, hand and body gestures, or other actions.

In some embodiments, the mood may be selected by a user. For example, the mood ring 1406 shown in FIG. 14 may be used to select and/or display an emotional state associated with the avatar. In some embodiments, an emotional state may have different degrees. For example, an avatar may appear to be slightly annoyed, annoyed, or very annoyed.

In some embodiments, the mood may be dynamically determined. For example, the avatar may automatically assume a particular emotional state when a video by a certain user in the three dimensional environment is displayed. These automatic reactions may be determined by identifying patterns in a user's actions. For instance, if a user typically changes the avatar's mood to a certain emotional state in a particular type of situation, then the system may begin to make this change automatically. Alternately, or additionally, these automatic reactions may be specified by a user. The user may be able to create rules specifying changes in emotional state that should occur in response to certain events.

A determination is made at 508 as to whether to exit the three dimensional environment. In some embodiments, this determination may be made in a manner substantially similar to the determination made at 110 in FIG. 1.

At 510, the three dimensional avatar is updated. Updating the three dimensional avatar may include any operations for causing the avatar to reflect the request to perform an action received at 506. In some cases, updating the avatar may include changing a static appearance of the avatar. For example, changing the avatar's mood to happy may cause the avatar's face to display a smile. As another example, the avatar's clothes, hair, color, shape, or other physical attributes may be changed.

In some cases, updating the avatar may include causing the avatar to change locations within the three dimensional environment. For example, the avatar may be moved from a location near one item of virtual content to another location near a different item of virtual content. As another example, the avatar may move from one location near or within a three dimensional model to a different location near or within a three dimensional model. In some embodiments, these moves may be used to reflect a change in focus of the user controlling the avatar to a different item of virtual content or to a different portion of the same item of virtual content. Alternately, or additionally, moving the avatar may be used to change the vantage point from which the three dimensional environment is displayed.

In some cases, updating the avatar may include causing the avatar to perform a gesture or other animated motion. For example, changing the avatar's mood to impatient may cause the avatar to display a toe-tapping or hand-waving gesture to signify impatience. As another example, interaction with content may cause the avatar to physically interact with content displayed in the three dimensional environment. Interaction with content is discussed in additional detail with respect to FIG. 6.

At 512, the three dimensional environment is updated to reflect the requested action. In some embodiments, updating the three dimensional may be substantially similar to the operation 112 shown in FIG. 1. The three dimensional environment may be updated to reflect an action performed by the user's avatar. For instance, if the avatar is moved from one location to another, then the vantage point from which the three dimensional environment is displayed may be changed as well.

At 514, the updated three dimensional environment is displayed on the display device. The updated three dimensional environment may reflect the updates to the avatar and the updates to the three dimensional environment itself. In some embodiments, the display of the updated three dimensional environment at operation 514 may be substantially similar to the display of the updated three dimensional environment at operation 114 shown in FIG. 1.

As shown in FIG. 5, the method 500 may be performed until a decision is made at 508 to exit the three dimensional environment. In some embodiments, the avatar and the three dimensional environment may be updated in response to input received at the computing device until the decision to exit is made. Performing the method 500 at the computing device may allow a user of the computing device to exercise control over the avatar and the three dimensional environment while viewing content within the three dimensional environment, thus providing the user with a sense of control over the virtual environment.

FIG. 6 shows a flow diagram of a method 600 for interacting with content, performed in accordance with one embodiment. The method 600 may be used to connect actions by the user interacting with content to the appearance of the user's avatar and the representations of the content within the three dimensional environment. Representing interactions with digital content as physical actions within the virtual environment displayed on the display screen may provide a sense of reality, space, and locality to the otherwise abstract experience of manipulating data. The interaction with content may be made more concrete, as the user can visualize the content as physical objects within a three dimensional world.

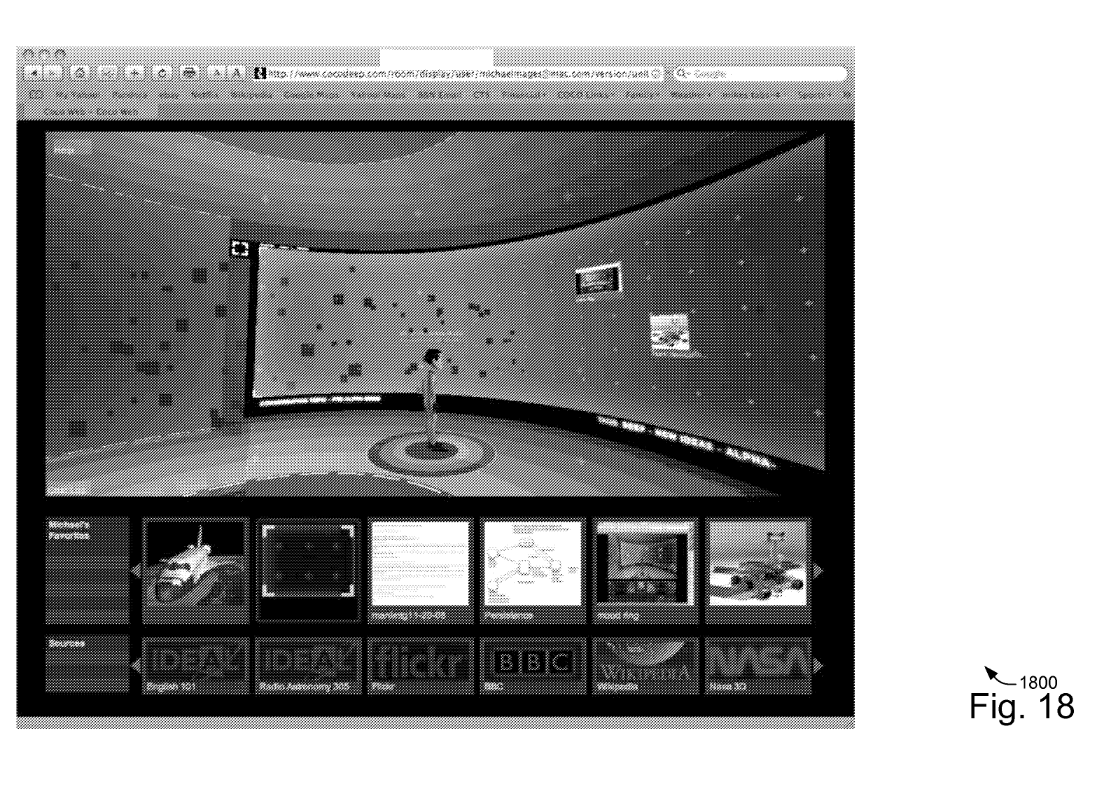

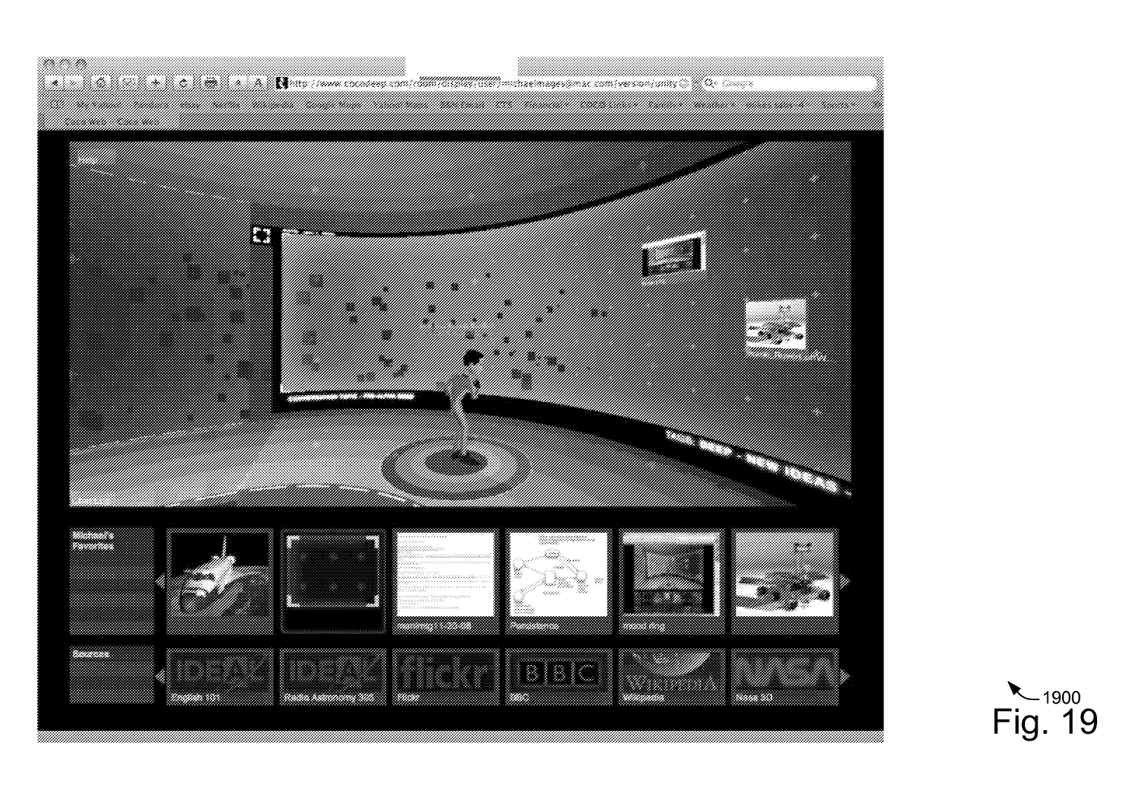

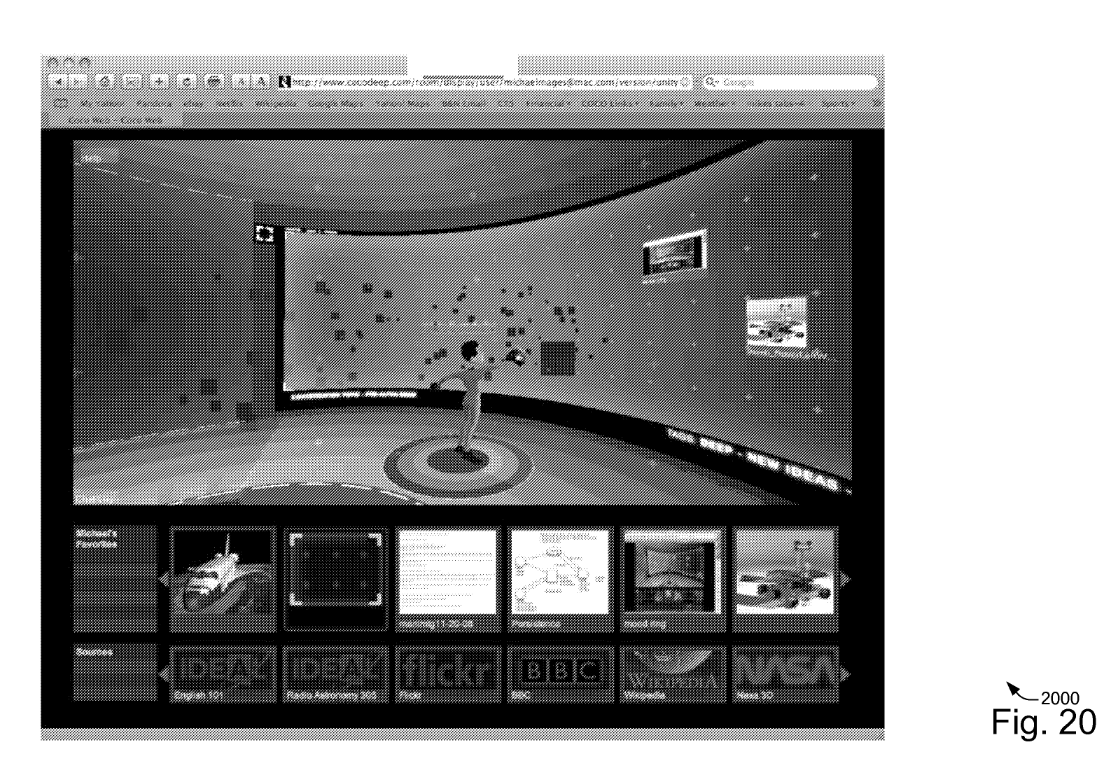

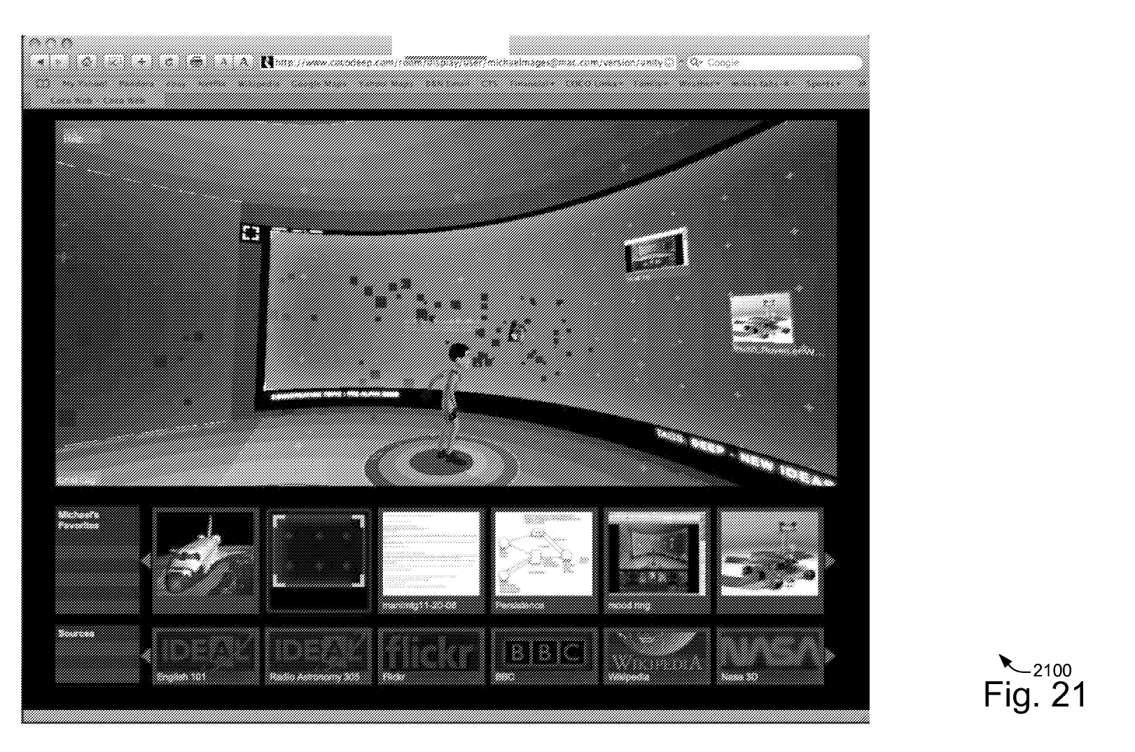

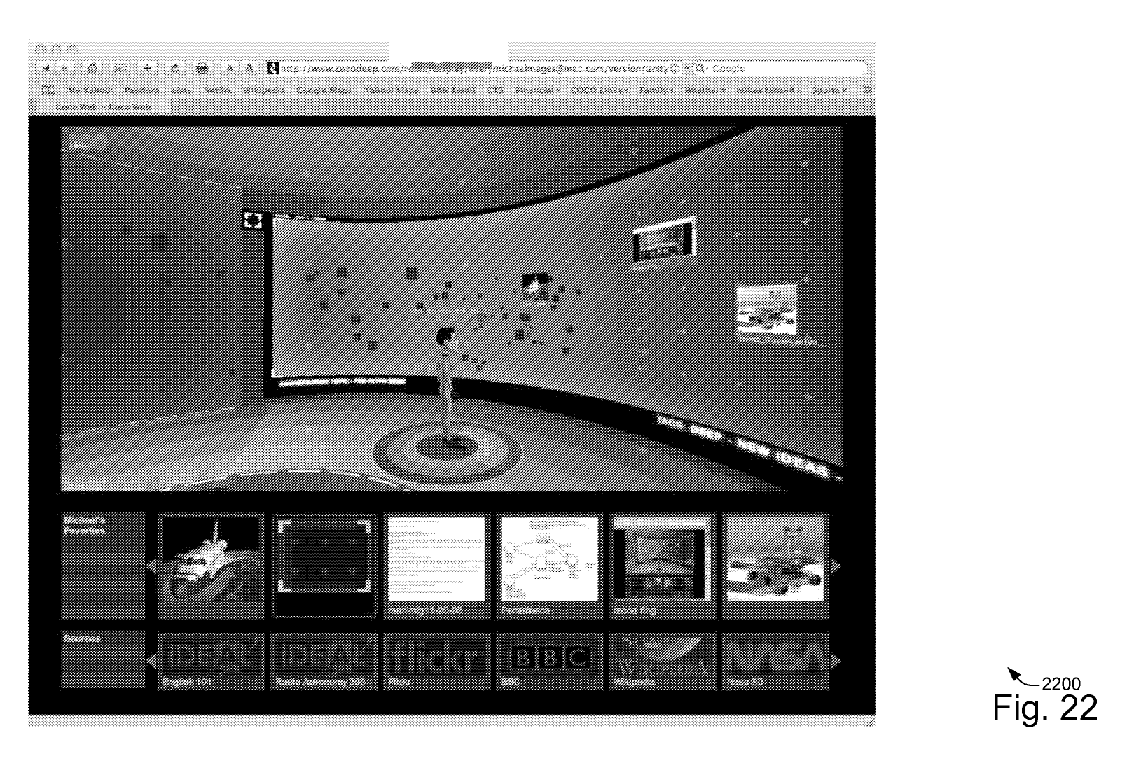

For example, a user may place content represented by thumbnail images on a virtual surface such as a three dimensional sharing wall. An example of the interaction between an avatar and content is shown in images 1800, 1900, 2000, 2100, and 2200 in FIGS. 18-22. Using a pointing device such as a mouse, pen, game controller control, digitizing tablet or a touch screen finger drag, the user can drag a thumbnail image from a two dimensional or three dimensional halo to a location over the three dimensional sharing wall. In the three dimensional environment shown in these images, the user is moving the content represented by the image of a space shuttle from the user's list of favorite content to the user's wall. Upon release of the pointing device, the thumbnail is ‘attached’ to the three dimensional sharing wall. The avatar performs an animated action as if it were throwing the thumbnail onto the wall. As this move occurs, the user's avatar is shown as taking content from the three dimensional halo over the avatar's head in FIGS. 18 and 19 and throwing the content onto the wall in FIGS. 20 and 21. In FIG. 22, the content appears on the wall in the location selected by the user and thrown to by the avatar.

In some embodiments, the converse action of dragging the thumbnail from the three dimensional sharing wall into the user's halo produces a similar animated action and results in a copy of the object from the three dimensional Sharing Wall to the user's halo.

At 602, a three dimensional environment is provided on a display screen of a computing device. At 604, content is retrieved and displayed within the three dimensional environment. At 606, a three dimensional avatar is generated and displayed within the three dimensional environment. In some embodiments, providing the three dimensional environment at operation 602 and generating and displaying the three dimensional avatar at 606 may be substantially similar to the operation 502 shown in FIG. 5. In some embodiments, retrieving and displaying content within the three dimensional environment at 604 may include operations substantially similar to the content presentation method 200 shown in FIG. 2.

At 608, user input is received. The user input may include any action in which content is added to the three dimensional environment, removed from the three dimensional environment, or interacted with in the three dimensional environment. For instance, a user may move content from a list to a virtual surface, as shown in FIGS. 18-22. A user may move also content on the virtual surface, share content with another user, download content to a local storage device, search for more content on a network such as the Internet, assign a label to content, connect one content item with another content item via an action relationship, enlarge or shrink a content item, combine different content items into a single content item, split a single content item into different content items, skew or transform a content item, save a content item to a remote server, edit text, edit video, perform three dimensional digital sculpting, perform three dimensional modeling, record and/or edit audio, perform three dimensional modeling and/or animation, perform collaborative software programming, perform a Microsoft® PowerPoint® presentation, or perform any other content-related action.

In some embodiments, the three dimensional environment may include editing software for manipulating content. For instance, a document editor for editing documents may be embedded so that documents may be edited on a virtual surface in the three dimensional environment.

At 610, a determination is made as to whether the exit the three dimensional environment. In some embodiments, the determination made at 610 may be substantially similar to the determination made at operation 508 shown in FIG. 5.

At 612, the content, the avatar, and the three dimensional environment are updated in response to the user input. In some embodiments, operation 612 may be substantially similar to the operation 512 shown in FIG. 5. The updating performed in operation 612 may reflect complex interaction between various portions of the three dimensional environment. For example, in response to user input moving a piece of content, the three dimensional environment may be updated to show any or all of: the content being moved, the avatar making a gesture representing a movement of the content, and the vantage point used to display the three dimensional environment changed to focus on the moved content.

At 614, the updated avatar, content, and three dimensional environment are displayed on the display device. In some embodiments, operation 614 may be substantially similar to operation 514 shown in FIG. 5.

FIG. 7 shows a flow diagram of a method 700 for collaborating on content, performed in accordance with one embodiment. The method 700 may be used to facilitate collaboration and interaction between a user of a local computing device on which a three dimensional environment is displayed and one or more users of remote computing devices in communication with the local computing device via a network. For example, a user of the local computing device and a user of a remote computing device may jointly manipulate content displayed on a virtual surface, may jointly interact with a three dimensional model displayed in a three dimensional content presentation area, may share content with each other, may communicate with each other, or perform any other action.

Displaying an avatar for each user may allow complex social interactions with data. For instance, a user can watch what another user's avatar is doing. Since the user's avatar may act out metaphors for moods of or actions performed by the user controlling the avatar watching the avatar may provide social cues as to the activities of the avatar's user. The user's avatar may be paying attention to certain content, standing next to another user's avatar, or navigating a three dimensional model. Watching avatars interact in the three dimensional environment may give visual clues as to social interactions in a digital world. For example, when a user shares content with another user, this digital exchange of data may be represented spatially by an action displayed within the three dimensional environment.

In some embodiments, collaboration between users may be synchronous or asynchronous. In synchronous interaction, two or more users may each be viewing a three dimensional environment and controlling avatars within the three dimensional environment. The two or more users may be mutually viewing, adding to, removing from, or modifying content. In asynchronous interaction, a user may perform actions in the three dimensional environment to interact with content. For instance, the user could add labels to portions of a three dimensional model and arrange videos on a virtual surface. Then, the user may store the interaction for viewing by another user. The interaction may be stored as a video recording all of the user's actions, as a copy of the wall or three dimensional model edited by the user, as a chat history, as a voice record, or as any other record. The interaction record may itself be treated as content. That is, the saved interaction record may be placed in a halo, on a wall, as a three dimensional model, or otherwise visualized within the three dimensional environment. Later, the other user may load the interaction for viewing or editing, and may save the edited interaction.

An example of collaboration between two users is shown in the three dimensional environment 1400 shown in FIG. 14. In FIG. 14, the avatars 1404 represent different users who are jointly interacting with the content displayed on the wall.

Another example of collaboration between two users is shown in the three dimensional environments 1500 and 1600 shown in FIGS. 15 and 16. In FIG. 15, the avatars are shown watching a video of a satellite displayed in the two dimensional viewing area 1502. FIG. 16 includes comment area 1602, in which one of the users gave the video a thumbs up and added a comment regarding the video.

In some embodiments, the methods described herein, including the content collaboration method 700, may facilitate complex interactions between users and content. The following paragraphs describe examples of the interactions that may be possible.

As a first example, a user may enter the three dimensional environment and appear as an avatar in the room. Other users may enter the room, or not. Each user may be located physically some distance apart and may be connected by the backend across a network such as the Internet. The user may place and arrange content from the two dimensional or three dimensional halos by dragging a thumbnail from the halo up and on to a three dimensional sharing wall. One or more of the avatars could select the mood ring and express an emotion in response to the content being placed on the three dimensional sharing wall. One of the users through their avatar may open one of the content objects that are on the three dimensional sharing wall so that it is displayed in the viewer. The viewer may open for other users viewing the three dimensional environment from other computing devices. Other users who have an avatar in the room may see the same content at the same time on the viewer.

As a second example, users may use a keyboard, mouse, touch panel, and other controls to move their avatars around the room, as in a video game. Users may move closer or farther from the content or other avatars. Controls may allow them to change the camera angle of the view of the room to enable new vantage points.

As a third example, one of the users may copy a content object from the three dimensional sharing wall to their own two dimensional or three dimensional halo using actions or gestures. Users may share files, links, or other content with each other. Users may also make a complete copy of the three dimensional sharing wall and save the copy to their two dimensional or three dimensional halos. Users may also copy complete collaboration instances. Saved walls may be reopened and used for further discussion with the same or other users in the same or another room.

As a fourth example, a chat dialog may be invoked so the users can communicate with each other. Chat text entered by one user may appear in a dialog in the instances of the room displayed on other computing devices where other users' avatars are present. Other users can respond with chats of their own. Chat history may be saved as a content object on the three dimensional sharing wall for future reference of the conversation around the content. VoIP may be used in the same fashion. When a content object is visible in the viewer to other users, the content object may have a comment attached to it by a user through actions by the user's avatar. Various three dimensional environment elements may allow users and their avatars to collaborate in real time with gestures and actions that provide for simple and easy collaboration.

In some embodiments, not all users viewing the three dimensional environment may have an avatar present in the three dimensional environment. For instance, the three dimensional environment may have a theater mode in which one or more avatars are presenting, and other users are watching the presentation. In this case, the users who are watching rather than participating may or may not be able to interact with content, change their vantage points, or perform other operations in the three dimensional environment.

The method 700 is discussed herein with respect to the operations that are performed on the local computing device on which the three dimensional environment is generated. However, various operations may be performed on other devices as well. For example, the same three dimensional environment, or a different three dimensional environment, may be displayed on a remote computing device in communication with the local computing device. In this way, the remote user can share the virtual space with the local user. As another example, one or both of the local computing device or the remote computing device may communicate with a server, as discussed with respect to FIGS. 3A-4.

In some embodiments, interaction between avatars controlled by users at different computing devices may be facilitated by video game server software for providing shared virtual three dimensional worlds. The video game server software may be executed at a server in communication with the different computing devices via a network such as the Internet. The video game server software may perform actions such as event sharing, handshaking, and message passing that facilitate interaction between the different computing devices.

At 702, a three dimensional environment is provided on a display device of a local computing device. In some embodiments, the operations performed at 702 may be substantially similar to the three dimensional environment presentation method 100 shown in FIG. 1. In some embodiments, content may be displayed in the three dimensional environment, as discussed with respect to the content presentation method 200 shown in FIG. 2. In some embodiments, semantic content information may be retrieved and used to display content, as discussed with respect to the semantic content retrieval method 350 shown in FIG. 3B and the system 400 shown in FIG. 4. In some embodiments, an avatar controlled by a user of the local machine may be displayed in the three dimensional environment, as discussed with respect to the avatar presentation method 500 shown in FIG. 5.

At 704, an avatar associated with a user in communication with the local machine via a network is displayed in the three dimensional environment. In some embodiments, the display of the avatar at 704 may be substantially similar to the presentation of an avatar discussed with respect to FIG. 5. However, the avatar displayed at 704 at the local computing device is controlled via the network by a remote user.

At 706, a request is received via the network to perform an action. In some embodiments, the request received at 706 may be substantially similar to the requests received at operation 506 in FIG. 5 and/or the user input received at 608 in FIG. 8, with the difference that the request received at 506 is received over the network. That is, the remote user may move the avatar, adjust the appearance of the avatar, interact with existing content, add content, remove content, or perform any other action within the three dimensional environment.

In some embodiments, user input may be received locally as well as remotely. For example, a request as described at operation 506 and/or user input as described at operation 608 may be received at the computing device on which the three dimensional environment is generated. In this way, both a local user and a remote user may be able to affect the display of the three dimensional environment on the local computing device.

At 708, the three dimensional environment is updated and displayed at the local computing device. The updated three dimensional environment includes any necessary updates to the remote avatar, the local avatar, and the content to perform the requested action. In some embodiments, the operation 708 may be substantially similar to the operations 512, 514, 612, and 614 shown in FIGS. 5 and 6, with the difference that in operation 708 at least some input is received via the network.

In some embodiments, the three dimensional environment may be updated and displayed at a remote computing device associated with the remote user as well as at the local computing device. To accomplish this, the local computing device may transmit three dimensional environment update information via the network to the remote computing device for updating the three dimensional environment. Then, the remote computing device may update a three dimensional environment displayed at the remote computing device.

A computer program product embodiment may include a tangible machine-readable storage medium (media) having instructions stored thereon/in which can be used to program a computer to perform any of the processes of the embodiments described herein. Computer code for operating and configuring systems to intercommunicate and to process web pages, applications and other data and media content as described herein may be downloaded and stored on a hard disk, but the entire program code, or portions thereof, may also be stored in any other memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for implementing embodiments can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used.

Computing devices typically includes one or more user interface devices, such as a keyboard, a mouse, trackball, touch pad, touch screen, pen or the like, for interacting with a graphical user interface (GUI) provided by the browser on a display (e.g., a monitor screen, LCD display, 3D display, etc.) in conjunction with pages, forms, applications and other information provided by systems or servers. For example, the user interface device can be used to access data and applications hosted by various systems, and to perform searches on stored data, and otherwise allow a user to interact with various GUIs that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

It should also be understood that “server system” and “server” may be used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

While various embodiments have been described herein, it should be understood that they have been presented by way of example only, and not limitation. Thus, the breadth and scope of the present application should not be limited by any of the embodiments described herein, but should be defined only in accordance with the following and later-submitted claims and their equivalents.

What is claimed is:

1. A method of displaying media content, the method comprising:
identifying, at a first computing device, media content for display in a virtual three dimensional environment, the media content being stored in a file independent of the virtual three dimensional environment, the media content capable of being displayed in a web browser;
generating the virtual three dimensional environment, the generated virtual three dimensional environment including a representation of the identified media content;
displaying the generated virtual three dimensional environment on a display device in communication with the first computing device, the virtual three dimensional environment displayed from a vantage point at a first location within the virtual three dimensional environment;
detecting input modifying the virtual three dimensional environment;
updating the virtual three dimensional environment in accordance with the detected input; and
displaying the updated virtual three dimensional environment on the display device.

2. The method recited in claim 1,
wherein the detected input comprises an action adding to, removing from, labeling, modifying, or moving the media content displayed in the virtual three dimensional environment.

3. The method recited in claim 1,
wherein the media content is represented in the virtual three dimensional environment as a plurality of images displayed on a virtual wall within the virtual three dimensional environment; and
wherein the detected input comprises moving a first one of the plurality of images with respect to a second one of the plurality of images.

4. The method recited in claim 3,
wherein one or more of the images represents a web page, the web page being capable of being enlarged and viewed within the virtual three dimensional environment.

5. The method recited in claim 4, the method further comprising:
retrieving the web page from a server via a network.

6. The method recited in claim 5, the method further comprising:
rendering the retrieved web page via a web browser, wherein generating the virtual three dimensional environment comprises positioning the rendered web page within the virtual three dimensional environment.

7. The method recited in claim 3,
wherein one or more of the images represents a video, the video being capable of being enlarged and played within the virtual three dimensional environment.

8. The method recited in claim 1,
wherein the media content comprises a three dimensional model; and
wherein generating the virtual three dimensional environment comprises positioning the three dimensional model within the virtual three dimensional environment.

9. The method recited in claim 1, the method further comprising:
identifying a media content type associated with the identified media content; and
identifying a rendering procedure for rendering media content of the identified media content type, wherein generating the virtual three dimensional environment comprises rendering the identified media content using the identified rendering procedure.

10. One or more computer readable media having instructions stored thereon for performing a method of displaying media content, the method comprising:
identifying, at a first computing device, media content for display in a virtual three dimensional environment, media content being stored in a file independent of the virtual three dimensional environment, the media content capable of being displayed in a web browser;
generating the virtual three dimensional environment, the generated virtual three dimensional environment including the identified media content;
displaying the generated virtual three dimensional environment on a display device in communication with the first computing device, the virtual three dimensional environment displayed from a vantage point at a first location within the virtual three dimensional environment;
detecting input modifying the virtual three dimensional environment, the input comprising an interaction with the identified media content;
updating the virtual three dimensional environment in accordance with the detected input; and
displaying the updated virtual three dimensional environment on the display device.

11. The one or more computer readable media recited in claim 10,
wherein the media content is represented in the virtual three dimensional environment as a plurality of images displayed on a virtual wall within the virtual three dimensional environment; and
wherein the detected input comprises moving a first one of the plurality of images with respect to a second one of the plurality of images.

12. The one or more computer readable media recited in claim 11, the method further comprising:
wherein the media content comprises a three dimensional model; and
wherein generating the virtual three dimensional environment comprises positioning the three dimensional model within the virtual three dimensional environment.

13. The one or more computer readable media recited in claim 10, the method further comprising:
identifying a media content type associated with the identified media content; and
identifying a rendering procedure for rendering media content of the identified media content type, wherein generating the virtual three dimensional environment comprises rendering the identified media content using the identified rendering procedure.

14. A method of displaying media content, the method comprising:
providing a virtual three dimensional environment for display on a display screen of a first computing device, the virtual three dimensional environment capable of being updated in response to input received at the first computing device, the virtual three dimensional environment including a first virtual character capable of being controlled via the first computing device;
displaying media content within the virtual three dimensional environment, the media content capable of being displayed in a web browser;
receiving first user input at the first computing device, the first user input manipulating the media content displayed in the virtual three dimensional environment; and
updating an appearance of the first virtual character on the display screen to reflect the manipulation of the media content.

15. The method recited in claim 14,
wherein the media content comprises a plurality of images displayed on a virtual surface within the virtual three dimensional environment.

16. The method recited in claim 14,
wherein the media content comprises a three dimensional model displayed in an area of the virtual three dimensional environment.

17. The method recited in claim 14, the method further comprising:
receiving second user input at the computing device, the second user input comprising a modification of a location, an action, or an appearance of the first virtual character; and
updating an appearance of the first virtual character to reflect the second user input.

18. The method recited in claim 14,
wherein the first user input comprises adding new media content to the virtual surface; and
wherein the appearance of the first virtual character is updated to include an animated gesture in which the first virtual character appears to throw the new media content onto the virtual surface.

19. The method recited in claim 14, wherein the virtual three dimensional environment includes a second virtual character capable of being controlled via a second computing device in communication with the first computing device via a network, the method further comprising:
receiving second user input via the network, the second user input manipulating the media content displayed in the virtual three dimensional environment; and
updating an appearance of the second virtual character on the display screen to reflect the manipulation of the media content.

20. The method recited in claim 19,
wherein the second user input comprises transferring a first portion of the media content from a user account associated with the second virtual character to a user account associated with the first virtual character;
wherein the appearance of the second virtual character is updated to include an animated gesture in which the second virtual character appears to throw the first portion of the media content to the first virtual character; and
wherein the appearance of the first virtual character is updated to include an animated gesture in which the first virtual character appears to catch the first portion of the media content.

21. A system for displaying media content, the system comprising:
a first computing device configured to:
provide a virtual three dimensional environment for display on a display screen, the virtual three dimensional environment capable of being updated in response to input received at the first computing device, the virtual three dimensional environment including a first virtual character capable of being controlled via the first computing device;
displaying media content within the virtual three dimensional environment, the media content capable of being displayed in a web browser;
receiving first user input at the first computing device, the first user input manipulating the media content displayed in the virtual three dimensional environment; and
update an appearance of the first virtual character on the display screen to reflect the manipulation of the media content.

22. The system recited in claim 21, the system further comprising:
a second computing device in communication with the first computing device via a network, the second computing device being configured to transmit second user input to the first computing device via the network, the second user input manipulating the media content displayed in the virtual three dimensional environment, the virtual three dimensional environment including a second virtual character capable of being controlled via the second computing device, wherein the first computing device is configured to update an appearance of the second virtual character on the display screen in response to receiving the second user input to reflect the manipulation of the media content.

23. The system recited in claim 22,
wherein the second user input comprises transferring a first portion of the media content from a user account associated with the second virtual character to a user account associated with the first virtual character;
wherein the appearance of the second virtual character is updated to include an animated gesture in which the second virtual character appears to throw the first portion of the media content to the first virtual character; and
wherein the appearance of the first virtual character is updated to include an animated gesture in which the first virtual character appears to catch the first portion of the media content.

24. The system recited in claim 21,
wherein the first user input comprises adding new media content to the virtual surface; and
wherein the appearance of the first virtual character is updated to include an animated gesture in which the first virtual character appears to throw the new media content onto the virtual surface.

25. The system recited in claim 21, wherein the first computing device is further configured to:
receive second user input at the computing device, the second user input comprising a modification of a location, an action, or an appearance of the first virtual character; and
update an appearance of the first virtual character to reflect the second user input.

26. The system recited in claim 21, the system further comprising:
one or more servers configured to:
facilitate communications between the first and second computing devices; and
store an indication of the media content displayed in the virtual three dimensional environment.

27. The system recited in claim 21,
wherein the second user input comprises transferring a first portion of the media content from a user account associated with the second virtual character to a user account associated with the first virtual character;
wherein the appearance of the second virtual character is updated to include an animated gesture in which the second virtual character appears to throw the first portion of the media content to the first virtual character; and
wherein the appearance of the first virtual character is updated to include an animated gesture in which the first virtual character appears to catch the first portion of the media content.

28. A method of displaying media content, the method comprising:
providing a virtual three dimensional environment for display on a display screen of a computing device, the virtual three dimensional environment capable of being updated in response to input received at the computing device;
displaying a first media item within the virtual three dimensional environment, the first media item being associated with an object displayed in the virtual three dimensional environment via an action relationship; and
storing a first indication of the first media item, the action relationship, and the object, the first indication capable of being retrieved to display media item associated with the object via the action relationship.

29. The method recited in claim 28,
wherein the first media item is capable of being displayed in a web browser, the first media item comprising media content selected from the group consisting of: an image file, a video file, an audio file, and a web page.

30. The method recited in claim 28,
wherein the action relationship specifies a location on the object to which the first media item is connected.

31. The method recited in claim 28,
wherein the object comprises a second media item, the second media item being capable of being displayed in a web browser, the second media item comprising media content selected from the group consisting of: an image file, a video file, an audio file, and a web page.

32. The method recited in claim 28,
wherein storing the indication comprises transmitting the indication to a server in communication with the computing device via the network.
